(19) United States
(12) Patent Application Publication
(10) Pub. No.: US 2004/0219981 A1
(43) Pub. Date: Nov. 4, 2004

(54) Game apparatus and storage medium having game program recorded therein

(75) Inventor: Taro Bando, Kyoto-shi (JP)

Correspondence Address: NIXON & VANDERHYE, PC, 1100 N GLEBE ROAD, 8TH FLOOR, ARLINGTON, VA, 22201-4714, US

(73) Assignee: Nintendo Co., Ltd., Kyoto (JP)

(21) Appl. No.: 10/781,868

(22) Filed: Feb. 20, 2004

(30) Foreign Application Priority Data
Apr. 30, 2003 (JP) 2003-125434

(51) Int. Cl. A63F 13/00

(52) U.S. Cl. 463/35

(57) ABSTRACT

Engine sounds corresponding to traveling actions of a car object in a game space are reproduced using previously recorded sound data obtained by running a real car, and therefore it is possible to reproduce engine sound close to a real engine's sound. When the car object is accelerating, corresponding acceleration sound data can be sequentially read and reproduced. Further, a deceleration sound data read position can be designated such that when the car object is operated so as to start decelerating during acceleration, deceleration sound data can be reproduced from a position corresponding to a position where reproduction of the acceleration sound data is stopped, whereby it is possible to combine the acceleration sound data and the deceleration sound data together so as not to result in unnatural sound data.

### BACKGROUND OF THE INVENTION

1. Field of the Invention

The present invention relates to a game apparatus, which generates the sound of movement in accordance with an action of an object which is moved in a game, and also relates to a storage medium having a program of the game recorded therein. More particularly, the present invention relates to a game apparatus, which generates the sound of an engine in accordance with a traveling action of a car object of a racing game in which the car object travels on a course in accordance with at least the player's accelerator operation, and also relates to a storage medium having a program of the racing game recorded therein.

2. Description of the Background Art

Conventionally, in a video game such as a racing game, the sound of an engine is reproduced in accordance with a traveling action of a car object traveling in a game space and/or the number of revolutions of the engine. In this conventional method for reproducing the sound of the engine, the sound of a real engine is previously recorded under prescribed driving conditions, and data of the recorded sound is loop-reproduced (i.e., reproduced repeatedly), while raising or lowering the frequency of the sound data in accordance with an increase or decrease in revolution speed of the engine of the car object during the game. However, when the frequency of a recorded waveform is changed, the sound quality tends to considerably differ from the original sound quality. Accordingly, for example, “Mario Cart 64™” developed by the present applicants employs such an improved technique as to crossfade between a previously registered sound of the engine at low speeds (a loop waveform of about one second) and a previously registered sound of the engine at high speeds (a loop waveform of about one second).

In a method as disclosed in Japanese Patent Laid-Open Publication No. 2000-10576, a waveform is previously stored as sound data for each of a plurality of ranges previously obtained by dividing each running state of the engine by a unit of length of time corresponding to one combustion cycle of rotation of the engine's crankshaft. In technology disclosed in Japanese Patent Laid-Open Publication No. 2000-10576, the sound level or the pitch of the waveform of the previously stored sound data is changed (i.e., a reproduction rate is increased or decreased) in accordance with the number of revolutions of the engine in a game space, such that simulated sound, which is closer to the sound of a real engine, can be generated using a small storage space.

However, there is a drawback in the technique which crossfades between a previously registered sound of an engine at low speeds and a previously registered sound of an engine at high speeds, because overlapping of these sounds results in impure sound quality. This technique, as well as the technique disclosed in Japanese Patent Laid-Open Publication No. 2000-10576, merely artificially replicate the sound of a real engine, and therefore the sound quality tends to considerably differ from the original sound quality. The sound of a real engine contains, for example, resonant sounds characteristic to the number of revolutions of the engine, sounds of intake and exhaust, mechanical sounds which are variable depending on the condition of load on the engine, and so on. However, these sounds contained in the real engine's sound cannot be accurately replicated by reproducing a simulated sound.

### SUMMARY OF THE INVENTION

Therefore, an object of the present invention is to provide a game apparatus capable of reproducing the sound of an engine which is close to a real engine's sound, and a storage medium having recorded therein a game program for use in such a game apparatus.

The present invention has the following features to attain the object mentioned above. It should be noted that reference numerals in brackets are provided in the following description in order to indicate correspondence with embodiments, which will be described for facilitating easy understanding of the present invention, rather than to limit the scope of the present invention.

A first aspect of the present invention is directed to a game apparatus which represents a game by a game image in which game an object (a car object) moves in accordance with a player's operation. The game apparatus includes an operating section (a controller 6), an acceleration sound storage section (an acceleration sound storage region 351 of an ARAM 35), a deceleration sound storage section (a deceleration sound storage region 352 of the ARAM 35), a read position calculating section (a CPU 30 which implements step S13, S21, S43, or S53; hereinafter, only step numbers are specified), a sound data reading section (S17, S25, S48, or S58), and a sound output control section (S17, S25, S48, or S58). The operating section inputs, in accordance with the player's operation (depressing or releasing of an A button 62), at least acceleration operation input data (to open an accelerator; S12 or S42) for accelerating a movement of the object and deceleration operation input data (to close the accelerator; S12 or S42) for decelerating a movement of the object. The acceleration sound storage section stores a series of acceleration sound data (acceleration sound data Du) of the object in accordance with action parameters (speed; address Au) of the object. The deceleration sound storage section stores a series of deceleration sound data (deceleration sound data Dd) of the object in accordance with the action parameters (speed; address Ad) of the object. The read position calculating section selects, based on operation input data inputted via the operating section, either one of the acceleration sound data and the deceleration sound data which are stored in the acceleration sound storage section and the deceleration sound storage section, respectively, and for calculating a read start position (address Au(a-1) or Ad(b-1)) of selected sound data corresponding to a current action parameter (speed) of the object. The sound data reading section sequentially reads, from the read start position, the sound data selected by the read position calculating section. The sound output control section emits, as a sound, the sound data read by the sound data reading section.

In the thus-configured game apparatus of the present invention, a series of acceleration sound or deceleration sound data, which are previously stored in accordance with action parameters of acceleration or deceleration actions of an object in a game, are sequentially reproduced in accordance with the action parameters, whereby it is possible to reproduce an acceleration or deceleration sound close to actual sound. Further, sound data to be reproduced is selected based on a traveling action of the object during the game, and therefore it is possible to emit the sound so as to be linked with the traveling action of the object represented on a game screen image.

For each change from one to the other between the acceleration operation input data and the deceleration operation input data which are inputted via the operating section (S12 or S42), the read position calculating section may change a calculation target at the read start position from one to the other between the acceleration sound data and the deceleration sound data (S13, S21, S43, or S53). In this case, the sound data read section sequentially reads, in response to a change of the calculation target of the read position calculating section, sound data newly targeted for calculation from the read start position (S17, S25, S48, or S58), thereby continuously reading different types of sound data before and after the change of the calculation target. Accordingly, if the player makes a change from an instruction to accelerate the object's speed to an instruction to decelerate the object's speed, or a change from an instruction to decelerate the object's speed to an instruction to accelerate the object's speed, sound data to be reproduced in accordance with such a change is changed from the acceleration sound data to the deceleration sound data or from the deceleration sound data to the acceleration sound data. These sound data are combined and read based on the object's parameter which is the same before and after the change. Accordingly, even if the object's traveling action is changed either from acceleration to deceleration or from deceleration to acceleration, the acceleration and deceleration sound data corresponding to the object's traveling action can be combined and emitted as sound. Further, a read start position of the acceleration sound data or the deceleration sound data is designated based on an action parameter of the object in the game, and therefore when combining both of the sound data together, it is possible to connect the sound data using the same action parameter as that at the read start position, whereby it is possible to combine the deceleration sound data and the acceleration sound data together so as not to result in unnatural sound data.

For example, when the sound data reading section is sequentially reading the acceleration sound data in response to the acceleration operation input data from the operating section, the deceleration operation input data is inputted from the operating section (S18 or S49). In responds to this, the read position calculating section calculates the read start position (address Ad(b-1)) of the deceleration sound data based on an action parameter corresponding to a read position of the acceleration sound data being read by the sound data reading section. Accordingly, when the player provides inputs for accelerating the object's speed during the game, corresponding acceleration sound data can be sequentially read and reproduced, and when inputs for decelerating the object's speed during acceleration are starting to be provided, a deceleration sound data read position, which corresponds to a position where reproduction of the acceleration sound data is stopped rather than to the beginning of the entire deceleration sound data, can be designated based on the object's action parameter. Accordingly, it is possible to combine the deceleration sound data and the acceleration sound data together, such that reproduced acceleration and deceleration sounds are not unnatural. Alternatively, when the sound data reading section is sequentially reading the deceleration sound data in response to the deceleration operation input data from the operating section, the acceleration operation input data is inputted from the operating section (S26 or S59). In response to this, the read position calculating section calculates the read start position (address Au(a-1)) of the acceleration sound data based on an action parameter corresponding to a read position of the deceleration sound data being read by the sound data reading section. Accordingly, when the player provides inputs for decelerating the object's speed during the game, corresponding deceleration sound data can be sequentially read and reproduced, and when inputs for accelerating the object's speed during deceleration are starting to be provided, an acceleration sound data read position, which corresponds to a position where reproduction of the deceleration sound data is stopped rather than to the beginning of the entire acceleration sound data, can be designated based on the object's action parameter. Accordingly, it is possible to combine the deceleration sound data and the acceleration sound data together, such that reproduced acceleration and deceleration sounds are not unnatural.

Further, the acceleration sound data stored in the acceleration sound storage section may contain at least sound data (acceleration sound data Du0 through Du(m-1)) corresponding to an acceleration range where the object accelerates from a minimum speed (a speed of 0) to a maximum speed (maximum speed vₘₐₓ) at a constant acceleration rate. The deceleration sound data stored in the deceleration sound storage section may contain at least sound data (deceleration sound data Dd0 through Dd(m-1)) corresponding to a deceleration range where the object decelerates from the maximum speed to the minimum speed at a constant deceleration rate. Accordingly, the acceleration sound data and the deceleration sound data, which are previously stored in the acceleration sound storage section and the deceleration sound storage section, respectively, are sound data obtained by acceleration at a constant acceleration rate and deceleration at a constant deceleration rate. Therefore, it is possible to reproduce acceleration and deceleration sounds which achieve smooth acceleration or deceleration at a constant acceleration or deceleration rate in a range between a minimum speed and a maximum speed. For example, the acceleration sound data stored in the acceleration sound storage section may further contain sound data (acceleration sound data Du(m) through Du(n-1)) corresponding to a maximum and constant speed range, where the object moves at the maximum and constant speed, and the sound data corresponding to a maximum and constant speed range is sequential in address to the sound data corresponding to the acceleration range. If the acceleration operation input data is continuously inputted from the operating section for a period of a prescribed time or more, the sound data reading section repeatedly reads the acceleration sound data corresponding to the maximum and constant speed range (S20 or S52). Accordingly, in the case where the object is moving at a maximum and constant speed, it is possible to endlessly reproduce the sound of the object's movement. Further, in the case where the object accelerates to the maximum speed and thereafter moves at the maximum and constant speed, it is possible to reproduce a natural sound of movement into which two different types of sounds are combined. Further, the deceleration sound data stored in the deceleration sound storage section may further contain sound data (deceleration sound data Dd(m) through Dd(n-1)) corresponding to a minimum and constant speed range, where the object moves at the minimum and constant speed, and the sound data corresponding to a minimum and constant speed range is sequential in address to the sound data corresponding to the deceleration range. If the deceleration operation input data is continuously inputted from the operating section for a period of a prescribed time or more, the sound data reading section repeatedly reads the deceleration sound data corresponding to the minimum and constant speed range (S28 or S61). Accordingly, in the case where the object is moving at a minimum and constant speed or stops moving, it is possible to endlessly reproduce the sound of the object's movement or the sound of the object in a resting state. Further, in the case where the object decelerates to the minimum speed and thereafter moves at the minimum and constant speed or stops moving, it is possible to reproduce a natural sound into which two different types of sounds are combined.

For example, the operating section may be able to input acceleration operation input data for accelerating the movement of the object at an arbitrary rate of speed (a degree of the accelerator's opening) in accordance with a degree of operation (a degree of pressure onto an R button 66a) designated by the player. The sound output control section includes an acceleration sound frequency correcting section (S45 or S50). The acceleration sound frequency correcting section corrects a frequency of the acceleration sound data read by the sound data reading section in accordance with a rate of acceleration movement (an accelerator opening degree correction coefficient ak) indicated by the acceleration operation input data. Accordingly, even in the case of a game which enables the player to move the object at an arbitrary acceleration speed, a series of acceleration sound data, which are previously stored in accordance with action parameters of acceleration actions of the object in the game, are sequentially reproduced in accordance with the acceleration actions of the object, and therefore it is possible to reproduce an acceleration sound close to actual acceleration sound. Further, by correcting the frequency of the acceleration sound in accordance with a rate of acceleration movement, it is made possible to reproduce a natural sound of acceleration. Alternatively, the operating section may be able to input deceleration operation input data for decelerating the movement of the object at an arbitrary rate of speed (an intensity of braking power) in accordance with a degree of operation (a degree of pressure onto an L button 66b) designated by the player. The sound output control section may include a deceleration sound frequency correcting section (S55). The deceleration sound frequency correcting section corrects a frequency of the deceleration sound data read by the sound data reading section in accordance with a rate of deceleration movement (a braking intensity correction coefficient bk) indicated by the deceleration operation input data. Accordingly, even in the case of a game which enables the player to move the object at an arbitrary deceleration speed, a series of deceleration sound data, which are previously stored in accordance with action parameters of deceleration actions of the object in the game, are sequentially reproduced in accordance with the deceleration actions of the object, and therefore it is possible to reproduce a deceleration sound close to actual deceleration sound. Further, by correcting the frequency of the deceleration sound in accordance with a rate of deceleration movement, it is made possible to reproduce a natural sound of deceleration.

Specifically, the object is a vehicle, and the action parameter corresponds to a speed of the vehicle. Accordingly, even in the case of, for example, a racing game in which a car object travels on a course, effects similar to those as described above can be achieved.

A second aspect of the present invention is directed to a storage medium having recorded therein a game program causing a computer, which includes an operating section (the controller 6) operated by a player, to implement a process for representing a game by a game image in which game an object moves in accordance with the player's operation. The game program causing the computer to implement an input step (S12 or S42), a read position calculating step (S13, S21, S43, or S53), a sound data reading step (S17, S25, S48, or S58), and a sound output control step (S17, S25, S48, or S58). The input step inputs, in accordance with an operation of the operating section, at least acceleration operation input data for accelerating a movement of the object and deceleration operation input data for decelerating a movement of the object. The read position calculating step selects, based on operation input data inputted at the input step, either one of the object's acceleration sound data and deceleration sound data, which are sequential to each other and previously stored in accordance with action parameters of the object, and for calculating a read start position of selected sound data corresponding to a current action parameter of the object. The sound data reading step sequentially reads, from the read start position, the sound data selected at the read position calculating step. The sound output control step emits, as a sound, the sound data read at the sound data reading step.

In the thus-configured storage medium of the present invention having recorded therein a game program to be implemented by a computer, a series of acceleration sound or deceleration sound data, which are previously stored in accordance with action parameters of acceleration or deceleration actions of an object in a game, are sequentially reproduced in accordance with the action parameters, and therefore it is possible to reproduce an acceleration or deceleration sound close to actual sound. Further, sound data to be reproduced is selected based on a traveling action of the object in the game, and therefore it is possible to emit the sound so as to be linked with the traveling action of the object represented on a game screen image.

For each change from one to the other between the acceleration operation input data and the deceleration operation input data which are inputted via the operating section at the input step, the read position calculating step may change a calculation target at the read start position from one to the other between the acceleration sound data and the deceleration sound data. In this case, the sound data read step sequentially reads, in response to a change of the calculation target at the read position calculating step, sound data newly targeted for calculation from the read start position, thereby continuously reading different types of sound data before and after the change of the calculation target.

For example, when the sound data reading step is sequentially reading the acceleration sound data in response to the acceleration operation input data inputted at the input step, the input step inputs the deceleration operation input data. In response to this, the read position calculating step calculates the read start position of the deceleration sound data based on an action parameter corresponding to a read position of the acceleration sound data being read at the sound data reading step. Alternatively, when the sound data reading step is sequentially reading the deceleration sound data in response to the deceleration operation input data inputted at the input step, the input step inputs the acceleration operation input data. In response to this, the read position calculating step calculates the read start position of the acceleration sound data based on an action parameter corresponding to a read position of the deceleration sound data being read at the sound data reading step.

Further, the previously stored acceleration sound data may contain at least sound data corresponding to an acceleration range where the object accelerates from a minimum speed to a maximum speed at a constant acceleration rate. The previously stored deceleration sound data may contain at least sound data corresponding to a deceleration range where the object decelerates from the maximum speed to the minimum speed at a constant deceleration rate. Alternatively, the previously stored acceleration sound data may further contain sound data corresponding to a maximum and constant speed range, where the object moves at the maximum and constant speed, and the sound data corresponding to a maximum and constant speed range is sequential in address to the sound data corresponding to the acceleration range. If the acceleration operation input data is continuously inputted at the input step for a period of a prescribed time or more, the sound data reading step repeatedly reads the acceleration sound data corresponding to the maximum and constant speed range. Alternatively still, the previously stored deceleration sound data may further contain sound data corresponding to a minimum and constant speed range, where the object moves at the minimum and constant speed, and the sound data corresponding to a minimum and constant speed range is sequential in address to the sound data corresponding to the deceleration range. If the deceleration operation input data is continuously inputted at the input step for a period of a prescribed time or more, the sound data reading step repeatedly reads the deceleration sound data corresponding to the minimum and constant speed range.

For example, the input step inputs acceleration operation input data for accelerating the movement of the object at an arbitrary rate of speed in accordance with a degree of operation designated by the player via the operating section. The sound output control step includes an acceleration sound frequency correcting step (S45 or S50). The acceleration sound frequency correcting step corrects a frequency of the acceleration sound data read at the sound data reading step in accordance with a rate of acceleration movement indicated by the acceleration operation input data. Alternatively, the input step inputs deceleration operation input data for decelerating the movement of the object at an arbitrary rate of speed in accordance with a degree of operation designated by the player via the operating section. The sound output control step includes a deceleration sound frequency correcting step (S55). The deceleration sound frequency correcting step corrects a frequency of the deceleration sound data read at the sound data reading step in accordance with a rate of deceleration movement indicated by the deceleration operation input data.

Specifically, the object is a vehicle, and the action parameter corresponds to a speed of the vehicle.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an external view for explaining game systems according to first and second embodiments of the present invention;

FIG. 2 is a functional block diagram of a game apparatus 3 shown in FIG. 1;

FIG. 3 is a schematic memory map for explaining exemplary programs and data to be stored in a main memory 33 shown in FIG. 2;

FIG. 4A is a graph showing an example of acceleration sound data to be previously obtained;

FIG. 4B is a graph for explaining exemplary conditions for previously obtaining the acceleration sound data shown in FIG. 4A;

FIG. 5A is a graph showing an example of deceleration sound data to be previously obtained;

FIG. 5B is a graph for explaining the exemplary conditions for previously obtaining the deceleration sound data shown in FIG. 5A;

FIG. 6 is a schematic memory map of an ARAM 35 shown in FIG. 2, having stored therein the acceleration sound and the deceleration sound data which are shown in FIGS. 4A and 5A, respectively;

FIG. 7 is a flowchart illustrating the procedure of an engine sound reproduction process performed by the game apparatus 3 shown in FIG. 1 in accordance with the first embodiment;

FIG. 8 is a graph for explaining acceleration and deceleration sound data to be used when a car object in an idling state accelerates to maximum speed vₘₐₓ and thereafter decelerates back into the idling state in accordance with the procedure of the flowchart of FIG. 7;

FIG. 9 is a graph for explaining acceleration and deceleration sound data to be used when a car object in an idling state accelerates to speed v₁ lower than maximum speed vₘₐₓ, temporarily decelerates to speed v₂ (v₂<v₁), and thereafter reaccelerates to the maximum speed vₘₐₓ in accordance with the procedure of the flowchart of FIG. 7; and

FIG. 10 is a flowchart illustrating the procedure of an engine sound reproduction process performed by a game apparatus 3 according to a second embodiment as shown in FIG. 1.

### DESCRIPTION OF THE PREFERRED EMBODIMENTS

### First Embodiment

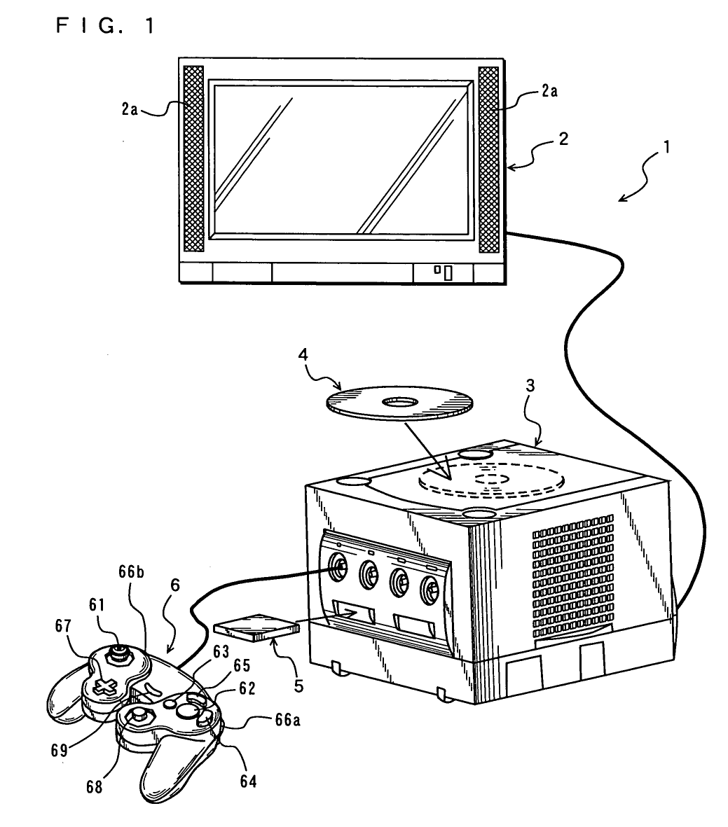

Hereinbelow, a first embodiment of the present invention will be described by taking a nonportable game apparatus as an example. Referring to FIG. 1, a game system 1 according to the first embodiment of the present invention is described. FIG. 1 is an external view for explaining the game system 1.

In FIG. 1, the game system 1 includes a nonportable game apparatus 3 (hereinafter, simply referred to as a “game apparatus 3”) connected via a connection cord to a cathode ray tube (CRT) display 2 (hereinafter, referred to as a “monitor 2”), such as a household television receiver, which includes loudspeakers 2a. The game apparatus 3 includes a controller 6 connected thereto via a connection cord and an optical disc 4 which is an example of a data storage medium which is removable from the game apparatus 3. Further, an external memory card 5, which has a backup memory or the like incorporated therein for storing save data, etc., in a non-volatile manner, is detachably loaded into the game apparatus 3 as necessary. The game apparatus 3 implements a game program stored in the optical disc 4 to display a game image on the monitor 2. Further, the game apparatus 3 uses the save data stored in the external memory card 5 to restore a previous game state and display a game image on the monitor 2. The player of the game apparatus 3 can enjoy the progress of the game by operating the controller 6 while viewing the game image displayed on the monitor 2. In the present embodiment, an exemplary case where a racing game program stored in the optical disc 4 is implemented is described.

As described above, the controller 6 is connected to the game apparatus 3 via a connection cord detachable from the game apparatus 3. Specifically, the controller 6 is an operating means for mainly operating a player object which appears in a game space displayed on the monitor 2 (and which is typically a car object which is an operation target of the player). The controller 6 includes a plurality of input portions, such as operating buttons, keys, and sticks. More specifically, the controller 6 includes: grip portions held by the player; a main stick 61 and a cross key 67 which are operable by, for example, the player's left thumb; a C stick 68, an A button 62, a B button 63, an X button 64, a Y button 65, and a start-pause button 69 which are operable by, for example, the player's right thumb. The controller 6 further includes an R button 66a and an L button 66b which are operable by, for example, the player's right and left index fingers, respectively.

For example, in the case of operating the controller 6 to play a racing game as described later, the A button 62 is used to determine an accelerator operation of the car object in the game space. For example, the player depresses the A button 62 to provide an instruction to accelerate the speed of the car object (to full-throttle), and the player releases the depressed A button 62 to cease providing an instruction to accelerate thereby ceasing to accelerate the speed of the car object (i.e., an instruction to completely close the accelerator). Although other input portions may be used during the progress of the game as described later, they are not directly relevant to descriptions of the present invention, and therefore detailed descriptions thereof are omitted herein.

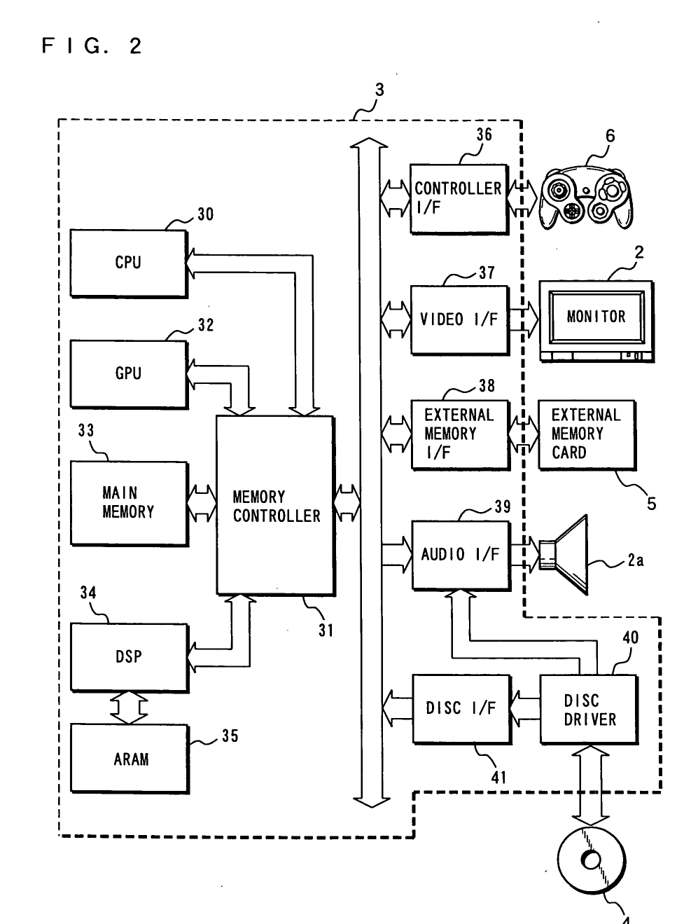

Next, referring to FIG. 2, a configuration of the game apparatus 3 will be described. FIG. 2 is a functional block diagram of the game apparatus 3.

In FIG. 2, the game apparatus 3 includes, for example, a reduced instruction set computer (RISC) central processing unit (CPU) 30 for implementing various types of programs. For example, the CPU 30 implements a startup program stored in a boot ROM (not shown) to initialize a memory, such as a main memory 33, and thereafter the CPU 30 implements a game program stored in the optical disc 4 and performs game processing in accordance with the game program. The CPU 30 is connected via a memory controller 31 to a graphics processing unit (GPU) 32, the main memory 33, a digital signal processor (DSP) 34, and an audio RAM (ARAM) 35. Further, the memory controller 31 is connected via a prescribed bus to a controller interface (I/F) 36, a video I/F 37, an external memory I/F 38, an audio I/F 39, and a disc I/F 41, which are respectively connected to the controller 6, the monitor 2, the external memory card 5, the loudspeakers 2a, and a disc drive 40.

The GPU 32 is operable to perform image processing in accordance with an instruction of the CPU 30, and is formed by a semiconductor chip for performing arithmetic processing required for displaying 3D graphics, for example. The GPU 32 performs image processing using a memory specialized for image processing (not shown) or a portion of storage area of the main memory 33. The GPU 32 uses these elements to generate game image data to bed is played on the monitor 2, and properly outputs the generated game image data to the monitor 2 via the memory controller 31 and the video I/F 37.

The main memory 33 is a storage area used by the CPU 30 and properly stores a game program, etc., required for processing by the CPU 30. For example, the main memory 33 stores a game program and a variety of types of data read by the CPU 30 from the optical disc 4. The game program and the variety of types of data stored in the main memory 33 are implemented by the CPU 30.

The DSP 34 is operable to process sound data, etc., generated by the CPU 30 during the implementation of the game program, and is connected to the ARAM 35 for storing the sound data, etc. The ARAM 35 is used when the DSP 34 performs prescribed processing (e.g., storage of pre-read data related to the game program and sound). The DSP 34 reads sound data stored in the ARAM 35, and outputs the read sound data through the memory controller 31 and the audio I/F 39 to the loudspeakers 2a included in the monitor 2.

The memory controller 31 is operable to generally control data transmission, and is connected to each of the above-described I/Fs. The controller I/F 36 consists of, for example, four controllers I/Fs 36a through 36d each having a connecter through which an external apparatus, which can be engaged with the connector, is connected so as to be able to communicate with the game apparatus 3. For example, the controller 6 is engaged with one of the above connectors via a connection cord, so as to be connected to the game apparatus 3 via the controller I/F 36. The video I/F 37 is connected to the monitor 2. The external memory I/F 38 is connected to the external memory card 5, so as to be able to access a backup memory included in the external memory card 5. The audio I/F 39 is connected to the loudspeakers 2a included in the monitor 2, such that sound data read by the DSP 34 from ARAM 35 and sound data directly outputted from the disc drive 40 can be outputted from the loudspeakers 2a. The disc I/F 41 is connected to the disc drive 40. The disc drive 40 reads data stored in the optical disc 4 placed in a prescribed read position, and outputs the read data over a bus of the game apparatus 3 and the audio I/F 39.

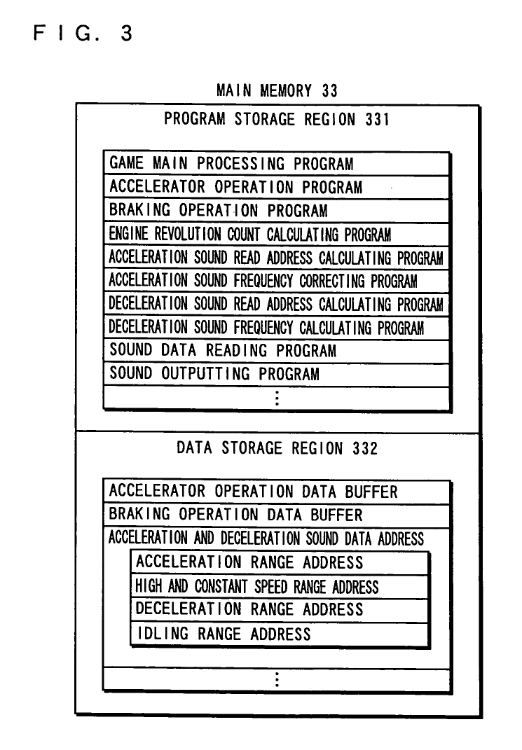

As described above, the main memory 33 stores a game program, etc., required for processing by the CPU 31, where appropriate, and also stores a game program, various types of data, etc., read by the CPU 30 from the optical disc 4. Herein below, referring to FIG. 3, exemplary programs and data to be stored in the main memory 33 when implementing the racing game of the present invention are described. FIG. 3 is a schematic memory map for explaining exemplary programs and data to be stored in the main memory 33.

In FIG. 3, the main memory 33 includes a program storage region 331 and a data storage region 332. Specifically, stored in the program storage region 331 are a game main processing program implemented by the CPU 30, accelerator and braking operation programs used by the game main processing program, an engine revolution count calculating program, an acceleration sound read address calculating program, a deceleration sound read address calculating program, an acceleration sound frequency correcting program, a deceleration sound frequency correcting program, a sound data reading program, a sound outputting program, etc. Further, stored in the data storage region 332 are accelerator and braking operation data buffers used by the game main processing program and so on, an acceleration and deceleration sound data address, etc. The acceleration and deceleration sound data address includes an acceleration range address, a deceleration range address, a high and constant speed range address, and an idling range address.

The accelerator operation program defines traveling actions of the car object each corresponding to the player's operation of opening the accelerator (e.g., depressing of the A button 62). The game program of the present invention is programmed such that, for example, when the car object is at a speed of 0, if the A button 62 is kept depressed for a time period from time 0 to time t₁, the car object reaches a maximum speed vₘₐₓ.

The braking operation program defines traveling actions of the car object each corresponding to the player's operation of closing the accelerator (e.g., releasing the A button 62). The game program of the present invention is programmed such that, for example, when the car object is at the maximum speed vₘₐₓ, if the A button 62 is left released for the time period from time 0 to time t₁, the car object decelerates to a speed of 0. This is an exemplary definition for the car object decelerating by means of engine braking, and an additional braking operation by the player (e.g., depressing of the B button 63 or the L button 66b) may cause deceleration from the maximum speed vₘₐₓ to the speed of 0 in a period of time shorter than the time period from time 0 to time t₁. However, in the first embodiment, it is assumed for simplicity of explanation that the player does not perform any braking operation (i.e., the car object decelerates only by means of engine braking). Processing related to braking operations will be described later in a second embodiment of the present invention.

The engine revolution count calculating program defines calculation related to the number of revolutions of the car object's engine. Typically, the number of revolutions of the engine is calculated in accordance with the speed of the car object calculated by the accelerator or braking operation program. However, the final number of revolutions of the engine is calculated in consideration of effects of road conditions (e.g., uphill, downhill, friction with tires, etc.) in the game space, as well as the calculated speed of the car object. For example, when a tire or tires of the car object is/are turning in the air, or when the number of turns of tires is zero due to a braking operation or the like, the number of revolutions of the engine is calculated so as to be higher than that for the speed of the car object.

The acceleration sound and deceleration sound read address calculating programs each define calculation related to an acceleration and deceleration sound data address for reading acceleration or deceleration sound data Du or Dd stored in the ARAM 35, which will be described later, in accordance with the speed of the car object calculated in a manner as described above. The acceleration sound and deceleration sound frequency correcting programs each define correction of the sound of the engine to be reproduced which is in accordance with the number of revolutions of the engine for the current speed of the car object. Detailed operations of these programs will be described later.

The sound data reading program defines processing for reading sound data from the ARAM 35. The sound data contains engine sound data used for loop-reproduction, which will be described later, and the acceleration and deceleration sound data Du and Dd corresponding to the acceleration and deceleration sound data address calculated by the acceleration sound and deceleration sound read address calculating programs. The sound outputting program defines processing for outputting the sound data read by the sound data reading program from the loudspeakers 2a via the memory controller 31 and the audio I/F 39.

The accelerator and braking operation data buffers each temporarily store the details of the player's accelerator operation as described above, and states of the speed of the car object and the number of revolutions of the engine which are influenced by the accelerator operation. The acceleration and deceleration sound data address includes addresses of the acceleration sound and deceleration sound data stored in the ARAM 35 which are stored for each type of sound. Specifically, the acceleration sound data includes engine sound data corresponding to an acceleration range and a high and constant speed range, and addresses of the engine sound data for both of the ranges in the ARAM 35 are stored as acceleration range addresses and high and constant speed range addresses. The deceleration sound data includes engine sound data corresponding to a deceleration range and an idling range, and addresses of the engine sound data for both of the ranges in the ARAM 35 are stored as deceleration range addresses and idling range addresses.

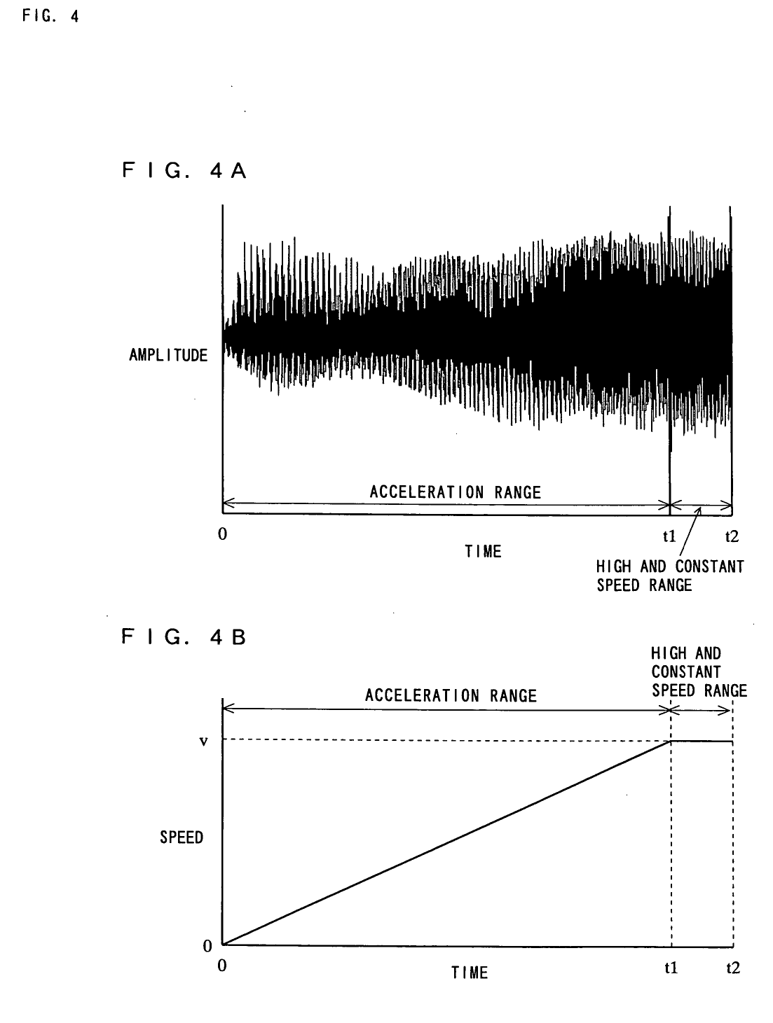

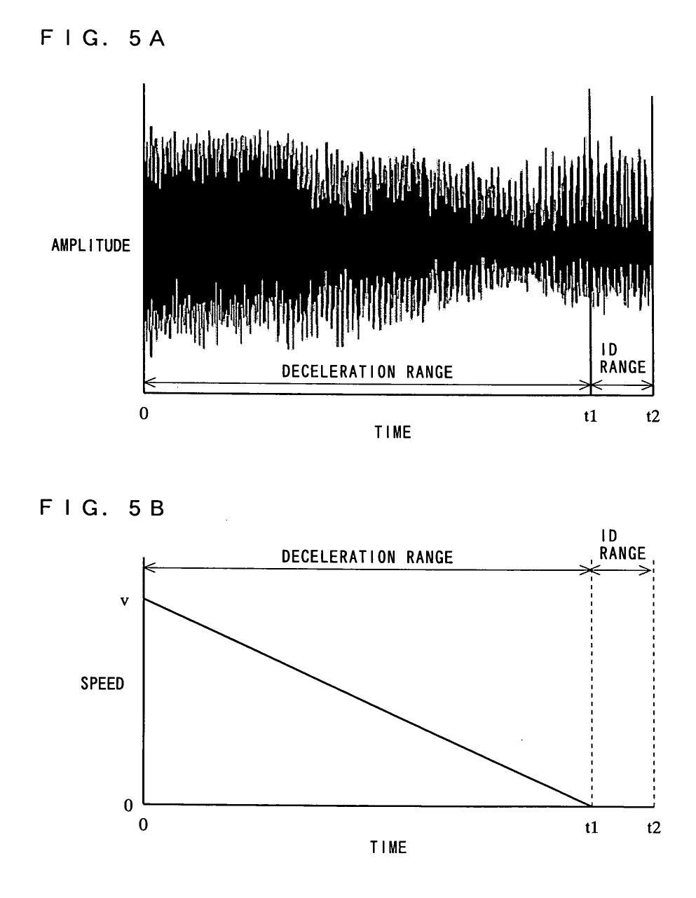

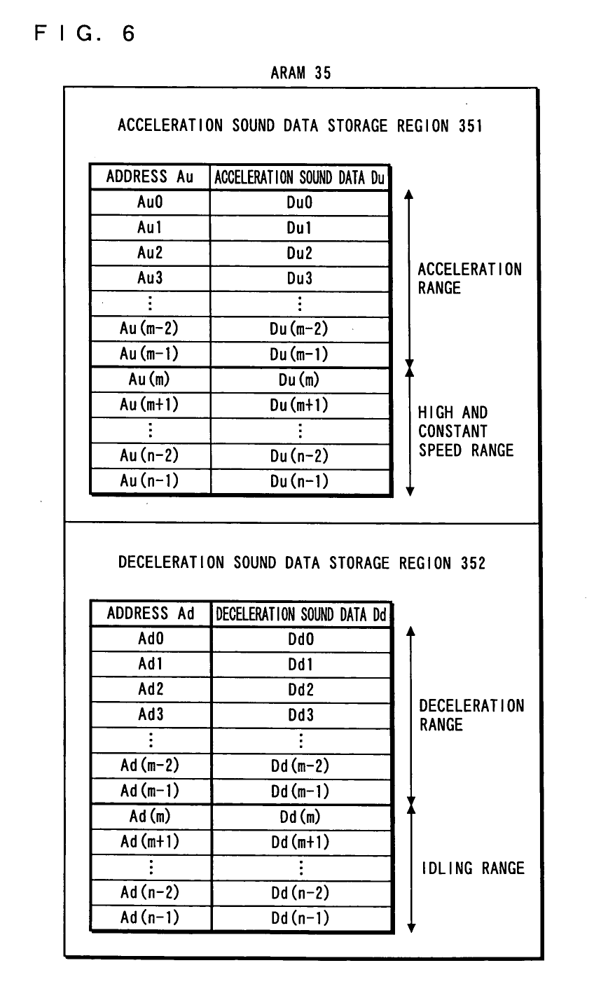

Next, referring to FIGS. 4A through 6, the acceleration sound data and the deceleration sound data which are stored in the ARAM 35 will be described. FIG. 4A is a graph showing an example of the acceleration sound data to be previously obtained. FIG. 4B is a graph for explaining exemplary conditions for previously obtaining the acceleration sound data shown in FIG. 4A. FIG. 5A is a graph showing an example of the deceleration sound data to be previously obtained. FIG. 5B is a graph for explaining the exemplary conditions for previously obtaining the deceleration sound data shown in FIG. 5A. FIG. 6 is a schematic memory map of the ARAM 35 having stored therein the acceleration sound and the deceleration sound data which are shown in FIGS. 4A and 5A, respectively.

The acceleration sound data shown in FIG. 4A is obtained by recording the noise of a real car which accelerates from a speed of 0 to speed v and thereafter travels at the constant speed v. Specifically, in the actual recording of the speed of the car, the car accelerates from a speed of 0 to the speed v at a constant acceleration rate in a period between times 0 and t₁, and maintains the constant speed v in a period between times t₁ and t₂ (see FIG. 4B). In this case, time t₁ corresponds to a point in time (e.g. t₁=8 sec.) at which the car object in the game space reaches a maximum speed vₘₐₓ after the A button 62 is kept depressed from a point in time at which the car object is at a speed of 0. The acceleration sound data recorded under such running conditions includes sound data of the car accelerating at a constant acceleration rate in the period between times 0 and t₁ (hereinafter, referred to as an “acceleration range”), and sound data of the car traveling at a constant high speed in the period between times t₁ and t₂ (hereinafter, referred to as a “high and constant speed range”) (see FIG. 4A). Such acceleration sound data is previously recorded at a sampling frequency of i Hz (e.g., 16 kHz) for a time period from time 0 to time t₂ (e.g., 10 sec.).

The deceleration sound data shown in FIG. 5A is obtained by recording the noise of a real car which decelerates from speed v to a speed of 0 and thereafter stops and runs in an idling (ID) state. Specifically, in the actual recording of the speed of the car, the car decelerates from the speed v to a speed of 0 at a constant deceleration rate in a period between times 0 and t₁, and maintains an idling and resting state in a period between times t₁ and t₂ (see FIG. 5B). In this case, time t₁ corresponds to a point in time (e.g. t₁=8 sec.) at which the car object in the game space reaches a speed of 0 after the A button 62 is left released from a point in time at which the car object is at a maximum speed vₘₐₓ. The deceleration sound data recorded under such running conditions includes sound data of the car decelerating at a constant deceleration rate in the period between times 0 and t₁ (hereinafter, referred to as an “deceleration range”), and sound data of the car resting in an idling state in the period between times t₁ and t₂ (hereinafter, referred to as an “idling range”) (see FIG. 5A). Such deceleration sound data is previously recorded at a sampling frequency of i Hz (e.g., 16 kHz) for a time period from time 0 to time t₂ (e.g., 10 sec.).

In FIG. 6, the ARAM 35 includes an acceleration sound data storage region 351 and a deceleration sound data storage region 352. The acceleration sound data recorded under the above-described conditions is stored in the acceleration sound data storage region 351. The acceleration sound data stored in the acceleration data storage region 351 is equally divided into n pieces of j-bit (e.g., 8-bit) acceleration sound data Du0 through Du(n-1). The acceleration sound data Du0 through Du(n-1) are stored as sound data at addresses Au0 through Au(n-1), respectively, in the acceleration sound data storage region 351. Accordingly, sound close to the previously recorded acceleration sound data is reproduced by sequentially reading, at a rate of (i/j) Hz, the acceleration sound data Du0 through Du(n-1) stored in the acceleration sound data storage region 351 and by reproducing the read acceleration sound data at a reproduction rate of i Hz. Among the previously recorded acceleration sound data, sound data corresponding to the acceleration range is stored as m pieces of acceleration sound data Du0 through Du(m-1) at addresses Au0 through Au(m-1), respectively. Further, among the previously recorded acceleration sound data, sound data corresponding to the high and constant speed range is stored as (n-m) pieces of acceleration sound data Du(m) through Du(n-1) at addresses Au(m) through Au(n-1), respectively.

The deceleration sound data recorded under the above-described conditions is stored in the deceleration sound data storage region 352. The deceleration sound data stored in the deceleration data storage region 352 is equally divided into n pieces of j-bit (e.g., 8-bit) deceleration sound data Dd0 through Dd(n-1). The deceleration sound data Dd0 through Dd(n-1) are stored as sound data at addresses Ad0 through Ad(n-1), respectively, in the deceleration sound data storage region 352. Accordingly, sound close to the previously recorded deceleration sound data is reproduced by sequentially reading, at a rate of (i/j) Hz, the deceleration sound data Dd0 through Dd(n-1) stored in the deceleration sound data storage region 352 and by reproducing the read deceleration sound data at a reproduction rate of i Hz. Among the previously recorded deceleration sound data, sound data corresponding to the deceleration range is stored as m pieces of deceleration sound data Dd0 through Dd(m-1) at addresses Ad0 through Ad(m-1), respectively. Further, among the previously recorded deceleration sound data, sound data corresponding to the idling range is stored as (n-m) pieces of deceleration sound data Dd(m) through Dd(n-1) at addresses Ad(m) through Ad(n-1), respectively.

Next, an operation of the game apparatus 3 based on a game program of the present invention is described by taking as an example a racing game in which a car object is controlled by the player's operation so as to travel on a course set in the game space. When the game apparatus 3 is turned on, the CPU 30 of the game apparatus 3 implements a startup program stored in a boot ROM (not shown) to initialize units in the game apparatus 3, e.g., the main memory 33. Then, a game program stored in the optical disc 4 is read onto the main memory 33 via the disc drive 40 and the disc I/F 41. Implementation of the game program is started and a game space is represented on the monitor 2 via the GPU 32. The acceleration sound and deceleration sound data stored in the optical disc 4 are stored into the ARAM 35 via the disc drive 40 and the disc I/F 41 in accordance with the addresses as described above.

Initially, the player of the game apparatus 3 views a game image displayed on the monitor 2 to select a desired course of the racing game and a type of the car object to operate. The selection is made by the player operating input portions of the controller 6 in a manner as described above. Then, a game image corresponding to the course and car object selected by the player is displayed on the monitor 2.

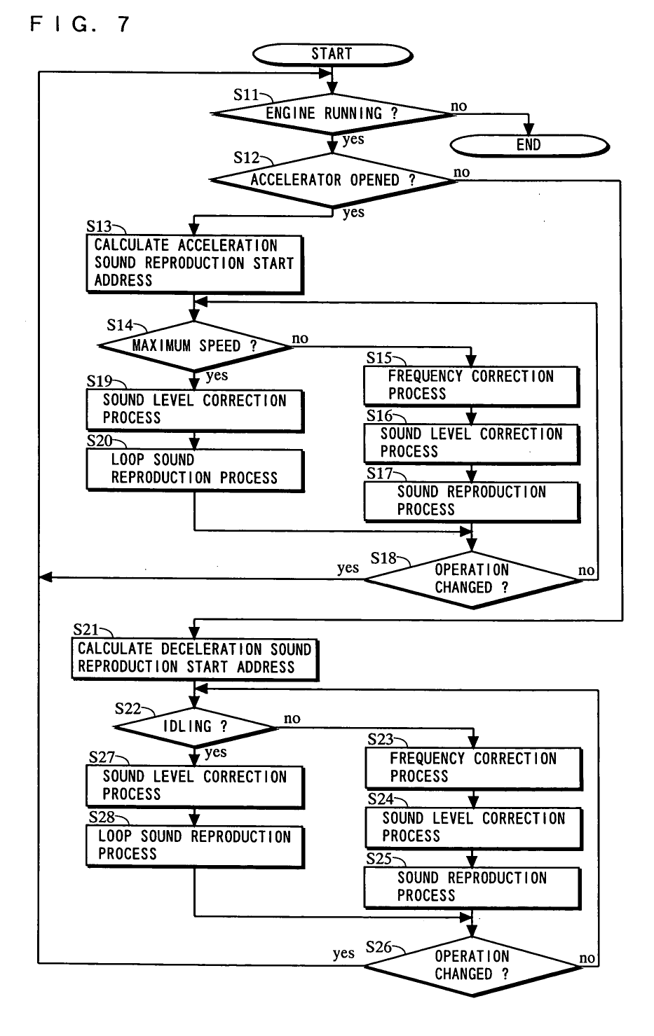

Referring to FIG. 7, described next is an engine sound reproduction process performed by the game apparatus 3 after the above process is performed. FIG. 7 is a flowchart illustrating the procedure of an engine sound reproduction process performed by the game apparatus 3.

In FIG. 7, the CPU 30 of the game apparatus 3 determines whether an engine of the car object in the game space is running (step S11), and also determines whether the accelerator is opened by the player operating the controller 6 (e.g., depressing the A button 62) (step S12). Then, if the CPU 30 determines that the engine of the car object is running and the accelerator is opened, the procedure proceeds to the next step S13, and if it is determined that the engine of the car object is running but the accelerator is closed, the procedure proceeds to the next step S21.

At step S13, in order to reproduce the sound of the engine of the car object which is accelerating, the CPU 30 calculates address Au of the acceleration sound data Du stored in the acceleration sound data storage region 351 of the ARAM 35, and the procedure proceeds to the next step. Specifically, in the calculation of step S13, the CPU 30 makes, based on the following expression (1), a calculation as to which one of m pieces of addresses Au0 through Au(m-1), at which the acceleration sound data Du corresponding to the acceleration range is stored, is the address from which the acceleration sound data Du is reproduced (an a'th address when counted from the address Au0).

a=mxvₓ/vₘₐₓ (1)

Here, vₓ is the current speed of the car object calculated based on numerical values stored in the accelerator and braking operation buffers of the data storage region 332. In this case, the numerical values are obtained based on a period of time for which the A button 62 is kept depressed and a period of time for which the A button 62 is left released which are cumulatively calculated from a point in time at which the car object is at a speed of 0. As described above, vₘₐₓ is a maximum speed reached by the car object as a result of keeping the accelerater opened. The CPU 30 sets address Au(a-1). which is the a'th address when counted from address Au0 and is obtained based on the above expression (1), as an acceleration sound reproduction start address from which reproduction of the sound of an engine is started in a manner to be described later.

Here, the CPU 30 calculates the acceleration sound reproduction start address by using the above expression (1) which multiplies the number of addresses m of the acceleration sound data Du corresponding to the acceleration range stored in the acceleration sound data storage region 351 by a ratio of the current speed vₓ of the car object to the maximum speed vₘₐₓ. As described above, the acceleration sound data Du stored in the acceleration sound data storage region 351 is obtained based on recorded sound data of the real car accelerating from a speed of 0 to speed v at a constant acceleration speed in a period between times 0 and t₁. The speed v of the real car is replaced by the maximum speed vₘₐₓ reached by the car object by keeping the accelerator opened from time 0 to time t₁ in the game. Such replacement ensures that the CPU 30 accurately calculates the address Au(a-1) at which acceleration sound of the real car, which corresponds to a ratio of the current speed vₓ of the car object to the maximum speed vₘₐₓ, is stored.

Next, the CPU 30 determines whether the speed of the car object in the game space has reached the maximum speed vₘₐₓ (step S14). If the car object has not reached the maximum speed vₘₐₓ, the CPU 30 determines that the car object is accelerating, and the procedure proceeds to the next step S15. On the other hand, if the car object has reached the maximum speed vₘₐₓ, the CPU 30 determines that the car object is traveling at the maximum speed vₘₐₓ in a high and constant speed state, and the procedure proceeds to the next step S19.

At step S15, the CPU 30 calculates a frequency correction coefficient used for reproducing the acceleration sound data Du stored at and after the acceleration sound reproduction start address Au(a-1) calculated at the above step S13, and the procedure proceeds to the next step. In general, the speed of the car object and the number of revolutions of the engine are in a relationship proportional to each other unless there is a transmission shift. In some cases, however, the speed and the number of revolutions of the engine depart from the above proportional relationship during the progress of the game. At the above step S15, the frequency correction coefficient is calculated, for example, for a case such that the player revs the engine of the car object at a speed of 0 in an idling state, or for a case such that a tire or tires are turning in the air. As described above, the CPU 30 calculates, as necessary, the number of revolutions of the car object's engine by means of the engine revolution count calculating program during the progress of the game. The frequency correction coefficient is calculated for reflecting a value of the number of revolutions of the engine at a prescribed ratio on the frequency of the acceleration sound data Du. For example, the frequency correction coefficient is set so as to fall within a range from 0.92 to 1.08.

Next, the CPU 30 calculates a sound level correction coefficient for correcting the sound level at which the sound of the engine is reproduced (step S16). In the racing game, a virtual camera for capturing the car object as a game image is set, and in some cases, the location of the virtual camera can be changed with respect to the car object. For example, the virtual camera may be set in the interior of the car object, or may be set for providing a bird's eye view of the car object. In accordance with a distance between such a virtual camera and the car object, the CPU 30 sets the sound level correction coefficient. For example, with reference to a reproduction sound level in a game image generated based on a viewpoint of the virtual camera set at a point at a prescribed distance from the car object, the CPU 30 calculates the sound level correction coefficient in accordance with an increase or decrease of a distance between the virtual camera and the point in the prescribed distance from the car object.

Next, the CPU 30 performs a process for reproducing acceleration sound data Du stored at and after the acceleration sound reproduction start address Au(a-1) calculated at the above step S13 (step S17), and repeats processing of steps S15-S17 until the player changes the accelerator operation (step S18) or until the car object reaches the maximum speed vₘₐₓ (step S14). If the CPU 30 determines that the player has changed the accelerator operation, the procedure returns to the above step S11 to continue the procedure. At the above step S17, the CPU 30 provides the DSP 34 with an instruction to sequentially read, as sound data, the acceleration sound data Du stored at and after the address Au(a-1) in the ARAM 35. Then, the DSP 34 multiplies the frequency of the sound data by the frequency correction coefficient obtained at the above step S15, adjusts a reproduction sound level using the sound level correction coefficient obtained at the step S16, and reproduces the sound of the engine from the loudspeakers 2a provided in the monitor 2 via the memory controller 31 and the audio I/F 39. In this sound reproduction process, unless the player's accelerator operation is changed (i.e., the accelerator is closed) or the car object reaches the maximum speed vₘₐₓ, previously recorded acceleration sound data is continuously reproduced using, as a reproduction start point, the acceleration sound reproduction start address calculated at the above step S13.

On the other hand, at the above step S14, if the car object has reached the maximum speed vₘₐₓ, the CPU 30 determines that the car object is traveling at the maximum speed vₘₐₓ in a high and constant speed state, and the procedure proceeds to step S19. At step S19, the CPU 30 calculates a sound level correction coefficient for correcting the sound level at which the sound of the engine is reproduced, and the procedure proceeds to the next step. Processing at step S19 is similar to that at the above step S16, and therefore detailed descriptions thereof are omitted.

Next, the CPU 30 performs a process for loop-reproducing acceleration sound data Du(m) through Du(n-1) stored at addresses Au(m) through Au(n-1) corresponding to the high and constant speed range (step S20). The procedure returns to step S19 to repeatedly perform this loop reproduction process so long as the player keeps the accelerator opened(step S18) and the car object travels in a high and constant speed state at the maximum speed vₘₐₓ (step S14). The CPU 30 provides the DSP 34 with an instruction to repeatedly read, as sound data, the acceleration sound data Du (m) through Du(n-1) corresponding to the high and constant speed range. The DSP 34 adjusts a reproduction sound level using the sound level correction coefficient obtained at the above step S19, and outputs the sound of the engine from the loudspeakers 2a provided in the monitor 2 via the memory controller 31 and the audio I/F 39. If the CPU 30 determines that the player has changed the accelerator operation (i.e., the accelerator is closed) (step S18), the procedure returns to the above step S11 to continue the procedure.

On the other hand, at the above step S12, if it is determined that the engine of the car object is running but the accelerator is closed, the procedure proceeds to step S21. At step S21, in order to reproduce the sound of the engine of the car object which is decelerating, the CPU 30 calculates address Ad of the deceleration sound data Dd stored in the deceleration sound data storage region 352 of the ARAM 35, and the procedure proceeds to the next step. Specifically, in the calculation of step S21, the CPU 30 makes, based on the following expression (2), a calculation as to which one of m pieces of addresses Ad0 through Ad(m-1), at which the deceleration sound data Dd corresponding to the deceleration range is stored, is the address from which the deceleration sound data Dd is reproduced (a b'th address when counted from the address Ad0).

b=m−(mxvₓ/vₘₐₓ) (2)

Here, vₓ is the current speed of the car object which is similar to the numerical value used at the above step S13, and vₘₐₓ is a maximum speed. The CPU 30 sets address Ad(b-1), which is the b'th address when counted from address Ad0 and is obtained based on the above expression (2), as a deceleration sound reproduction start address from which reproduction of the sound of the engine is started in a manner to be described later.

Here, the CPU 30 calculates the deceleration sound reproduction start address by using the above expression (2) which subtracts, from the number of addresses m of the deceleration sound data Dd corresponding to the deceleration range stored in the deceleration sound data storage region 352, a value obtained by multiplying the number of addresses m by a ratio of the current speed vₓ of the car object to the maximum speed vₘₐₓ. As described above, the deceleration sound data Dd stored in the deceleration sound data storage region 352 is obtained based on recorded sound data of the real car decelerating from speed v to a speed of 0 at a constant deceleration speed in a period between times 0 and t₁. The deceleration from speed v to the speed of 0 of the real car is replaced by the deceleration from the maximum speed vₘₐₓ to the speed of 0 by keeping the accelerator closed from time 0 to time t₁ in the game. Such replacement ensures that the CPU 30 accurately calculates the address Ad (b-1) at which deceleration sound of the real car, which corresponds to a ratio of the current speed vₓ of the car object to the maximum speed vₘₐₓ, is stored.

Next, the CPU 30 determines whether the speed of the car object in the game space corresponds to a speed of 0 in an idling state (step S22). If the car object is not in an idling state at a speed of 0, the CPU 30 determines that the car object is decelerating, and the procedure proceeds to the next step S23. On the other hand, if the CPU 30 determines that the car object is in an idling state at a speed of 0, the procedure proceeds to the next step S27.

At step S23, the CPU 30 calculates a frequency correction coefficient used for reproducing deceleration sound data Dd stored at and after the deceleration sound reproduction start address Ad(b-1) calculated at the above step S21, and also calculates a sound level correction coefficient for correcting a sound level at which the sound of the engine is reproduced (step S24). Processes performed at steps S23 and S24 are respectively similar to those performed at the above steps S15 and S16, and therefore detailed descriptions thereof are omitted. The procedure further proceeds to the next step.

Next, the CPU 30 performs a process for reproducing the deceleration sound data Dd stored at and after the deceleration sound reproduction start address Ad(b-1) calculated at the above step S21 (step S25), and repeats processing of steps S23-S25 until the player changes the accelerator operation (step S26) or until the car object arrives in an idling state at a speed of 0 (step S22). If the CPU 30 determines that the player has changed the accelerator operation (i.e., the accelerator is opened), the procedure returns to the above step S11 to continue the procedure. At the above step S25, the CPU 30 provides the DSP 34 with an instruction to sequentially read, as sound data, the deceleration sound data Dd stored at and after the address Ad(b-1) in the ARAM 35. Then, the DSP 34 multiplies the frequency of the sound data by the frequency correction coefficient obtained at the above step S23, adjusts a reproduction sound level using the sound level correction coefficient obtained at the step S24, and reproduces the sound of the engine from the loudspeakers 2a provided in the monitor 2 via the memory controller 31 and the audio I/F 39. In this sound reproduction process, unless the player's accelerator operation is changed (i.e., the accelerator is opened) or the car object arrives in an idling state at a speed of 0, previously recorded deceleration sound data is continuously reproduced using, as a reproduction start point, the deceleration sound reproduction start address calculated at the above step S21.

On the other hand, at the above step S22, if the CPU 30 determines that the car object is in an idling state at a speed of 0, the procedure proceeds to step S27. At step S27, the CPU 30 calculates a sound level correction coefficient for correcting the sound level at which the sound of the engine is reproduced, and the procedure proceeds to the next step. A process at step S27 is similar to that at the above step S16, and therefore detailed descriptions thereof are omitted.

Next, the CPU 30 performs a process for loop-reproducing deceleration sound data Dd(m) through Dd(n-1) stored at addresses Ad(m) through Ad (n-1) corresponding to the idling range (step S28). The procedure returns to step S27 to repeatedly perform this loop reproduction process so long as the player keeps the accelerator closed (step S26) and the car object maintains the idling state at a speed of 0 (step S22). The CPU 30 provides the DSP 34 with an instruction to repeatedly read, as sound data, the deceleration sound data Dd(m) through Dd(n-1) corresponding to the idling range stored at addresses Ad(m) through Ad(n-1) in the ARAM 35. The DSP 34 adjusts a reproduction sound level using the sound level correction coefficient obtained at the above step S27, and outputs the sound of the engine from the loudspeakers 2a provided in the monitor 2 via the memory controller 31 and the audio I/F 39. If the CPU 30 determines that the player has changed the accelerator operation (i.e., the accelerator is opened), the procedure returns to the above step S11 to continue the procedure.

If the CPU 30 determines at the above step S11 that the engine is not running, the engine sound reproduction process according to the flowchart of FIG. 7 is terminated.

Note that although the ARAM 35 has stored therein the acceleration sound data Du and the deceleration sound data Dd, each equally divided into n pieces of data, and each of a portion of the acceleration sound data Du corresponding to the acceleration range and a portion of the deceleration data Dd corresponding to the deceleration range is equally divided into m pieces of data, the number of pieces of data to be divided into may not be equally n or m. By performing the above-described processing based on the flowchart of FIG. 7 and making an address calculation using the above expressions (1) and (2), similar processing can be realized even if the number of pieces of data to be divided into is not equal between the acceleration sound data Du and the deceleration sound data Dd.

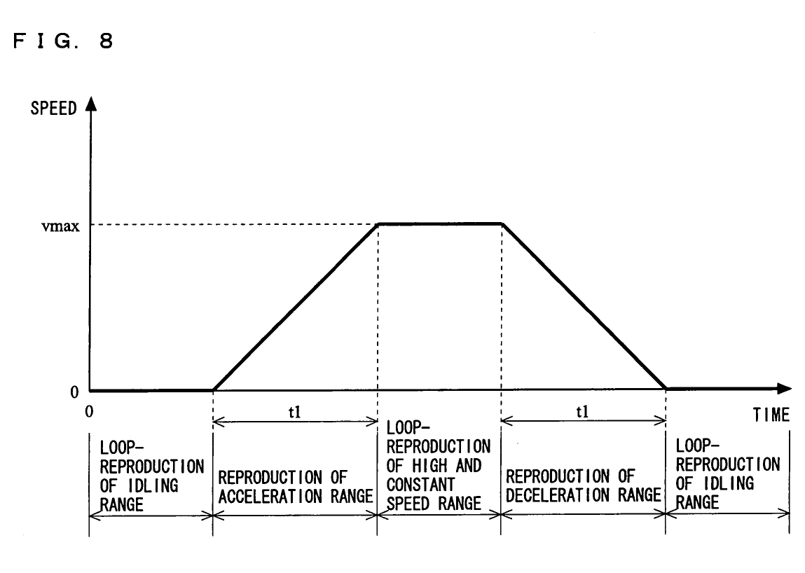

Referring to FIG. 8, described next is an example of the acceleration and deceleration sound data to be used by the game apparatus 3 in accordance with the procedure of the flowchart of FIG. 7. FIG. 8 is a graph for explaining the acceleration and deceleration sound data to be used when the car object in an idling state accelerates to the maximum speed vₘₐₓ and thereafter decelerates back into the idling state.

In FIG. 8, if the car object is in an idling state at a speed of 0, the game apparatus 3 implements loop-reproduction of the deceleration sound using the deceleration sound data Ad (m) through Ad(n-1) corresponding to the idling range stored in the deceleration sound data storage region 352 of the ARAM 35. Then, if the player performs an operation of opening the accelerator, acceleration sound data Du0, Du1, . . . , corresponding to the acceleration range stored in the acceleration sound data storage region 351 are sequentially reproduced from address Au0. Thereafter, if the player keeps the accelerator opened for a time period from time 0 to time t₁ or more, the car object reaches the maximum speed vₘₐₓ at a point in time when the time period from time 0 to time t₁ passes since the accelerator is opened. In the period up to time t₁, the game apparatus 3 sequentially reproduces the acceleration sound data Du0 through Du(m-1) corresponding to the acceleration range stored at addresses Au0 through Au(m-1) in the acceleration sound data storage region 351. Thereafter, if the player further continues the operation of opening the accelerator, the car object maintains the maximum speed vₘₐₓ. In a period during which the maximum speed vₘₐₓ is maintained, the game apparatus 3 performs loop-reproduction of acceleration sound using the acceleration sound data Du (m) through Du(n-1) corresponding to the high and constant speed range stored at addresses Au(m) through Au(n-1) in the acceleration sound data storage region 351.

Then, if the player performs an operation of closing the accelerator, deceleration sound data Dd0, Dd1, . . . , corresponding to the deceleration range stored in the deceleration sound data storage region 352 are sequentially reproduced from address Ad₀. Thereafter, if the player keeps the accelerator closed for a time period from time 0 to time t₁ or more, the car object arrives in an idling state at a speed of 0 after the time period from time 0 to time t₁ has passed since the accelerator was closed. In the period up to time t₁, the game apparatus 3 sequentially reproduces the deceleration sound data Dd0 through Dd(m-1) corresponding to the deceleration range stored at addresses Ad0 through Ad(m-1) in the deceleration sound data storage region 352. Thereafter, if the player further continues the operation of closing the accelerator closed, the car object maintains the idling state at a speed of 0. In a period during which the idling state is maintained, the game apparatus 3 performs, again, loop-reproduction of deceleration sound using the deceleration sound data Dd (m) through Dd(n-1) corresponding to the idling range stored at addresses Ad(m) through Ad(n-1) in the deceleration sound data storage region 352.

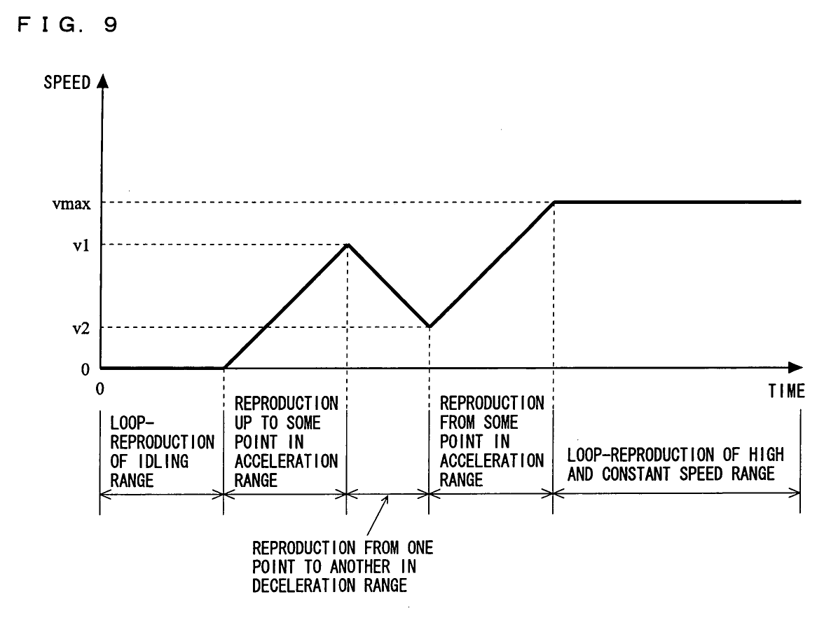

Referring to FIG. 9, described next is another example of the acceleration and deceleration sound data to be used by the game apparatus 3 in accordance with the procedure of the flowchart of FIG. 7. FIG. 9 is a graph for explaining the acceleration and deceleration sound data to be used when the car object in an idling state accelerates to speed v₁ lower than the maximum speed vₘₐₓ, temporarily decelerates to speed v₂ (v₂<v₁), and thereafter reaccelerates to the maximum speed vₘₐₓ.

In FIG. 9, if the car object is in an idling state at a speed of 0, the game apparatus 3 implements loop-reproduction of deceleration sound using the deceleration sound data Ad (m) through Ad(n-1) corresponding to the idling range stored in the deceleration sound data storage region 352 of the ARAM 35. Then, if the player performs an operation of opening the accelerator, acceleration sound data Du0, Du1, . . ., corresponding to the acceleration range stored in the acceleration sound data storage region 351 are sequentially reproduced from address Au0. Then, if the player stops the operation of opening the accelerator, the car object reaches speed v₁. In a period up until the car object reaches speed v₁, the game apparatus 3 sequentially reproduces the acceleration sound data Du up to an address corresponding to the above speed v₁ using the acceleration sound data Du0 through Du(m-1) corresponding to the acceleration range stored in the acceleration sound data storage region 351.

Then, if the player keeps the accelerator closed, the car object decelerates from speed v₁ to speed V₂ until an operation of opening the accelerator is performed again. In this time period, the game apparatus 3 sequentially reproduces the deceleration sound data Dd from an address corresponding to the above speed v₁ to an address corresponding to the above speed v₂ using the deceleration sound data Dd0 through Dd(m-1) corresponding to the deceleration range stored at the addresses Ad0 through Ad(m-1) in the deceleration sound data storage region 352.

Then, if the player performs, again, the operation of opening the accelerator, the car object accelerates from speed v₂, eventually reaching the maximum speed vₘₐₓ. In this time period, the game apparatus 3 sequentially reproduces the acceleration sound data Du from the address corresponding to the above speed v₂ to an address corresponding to the maximum speed vₘₐₓ using the acceleration sound data Du0 through Du(m-1) corresponding to the acceleration range stored at addresses Au0 through Au(m-1) in the acceleration sound data storage region 351. Thereafter, if the player further continues the operation for opening the accelerator, the car object maintains the maximum speed vₘₐₓ. In a time period during which the maximum speed vₘₐₓ is maintained, the game apparatus 3 implements loop-reproduction of acceleration sound using the acceleration sound data Du (m) through Du(n-1) corresponding to the high and constant speed range stored at addresses Au(m) through Au(n-1) in the acceleration sound data storage region 351.

As described above, in the game system 1 according to the first embodiment of the present invention, sounds of the engine corresponding to traveling actions, such as acceleration, deceleration, idling, and maximum and constant speed states, of the car object in the game space are reproduced using previously recorded sound data obtained by running a real car, and therefore it is possible to reproduce the sound of the engine close to the sound of the real car's engine. When inputs for accelerating the speed of the car object are provided during the game, corresponding acceleration sound data can be sequentially read and reproduced, and when inputs for decelerating the speed of the car object during acceleration are starting to be provided, a deceleration sound data read position, which corresponds to a position where reproduction of the acceleration sound data is stopped, can be designated. Therefore, it is possible to reproduce the natural sound of an engine using the acceleration sound data and the deceleration sound data as if they are originally continuous with each other. Further, when inputs for accelerating the speed of the car object during deceleration are starting to be provided, an acceleration sound data read position can be designated, such that the acceleration sound data can be reproduced from a position corresponding to a position where reproduction of the deceleration sound data is stopped, rather than from the beginning of the entire acceleration sound data. Therefore, it is possible to reproduce a more natural sound of an engine using the acceleration sound data and the deceleration sound data as if they are originally continuous with each other.

### Second Embodiment

A game system according to a second embodiment of the present invention is described. The game system implementing a game program according to the second embodiment includes analog switches which respectively enable the player to arbitrarily control the degree of the accelerator's opening and the intensity of braking power. Specifically, in the second embodiment, each of the degrees of acceleration and deceleration is set arbitrarily, while in the game system according to the first embodiment, a 100% opening of the accelerator is designated by depressing the A button 62 to provide acceleration, and a 0% opening of the accelerator is designated by releasing the A button 62 to provide deceleration by means of engine braking. The game system implementing such a game program is described as the second embodiment.

The game system according to the second embodiment is configured similarly to the game system 1 described in the first embodiment with reference to FIG. 1. Hereinbelow, like elements described in the first embodiment are denoted by the same reference numerals, and detailed descriptions thereof are omitted. Note that in the case of playing such a racing game as described below in the game system according to the second embodiment, for example, an R button 66a and an L button 66b provided in the controller 6 are used as the above analog switches. For example, the player applies arbitrary pressure onto the R button 66a (i.e., depresses the R button 66a with arbitrary pressure) to designate to the game apparatus 3 the degree of opening of the car object's accelerator, which ranges between 0% and 100%, in accordance with the pressure. For example, if the player depresses the R button 66a as far as possible, a 100% opening of the accelerator is designated, and by ceasing to depress (i.e., by releasing) the R button 66a, closing of the car object's accelerator (i.e., a 0% opening of the accelerator) is designated. Further, the player applies arbitrary pressure onto the L button 66b (i.e., depresses the L button 66b with arbitrary pressure) to designate to the game apparatus 3 the intensity of braking power of the car object, which ranges between 0% and 100%, in accordance with the pressure. For example, if the player depresses the L button 66b as far as possible, a 100% braking power is designated, and by ceasing to depress (i.e., by releasing) the L button 66b, releasing of the car object's braking (i.e., a 0% braking power) is designated.

The game apparatus 3 provided in the game system 1 according to the second embodiment is configured similarly to the game apparatus 3 described in the first embodiment with reference to FIG. 2. Hereinbelow, like elements described in the first embodiment are denoted by the same reference numerals, and detailed descriptions thereof are omitted.

Programs and data stored in the main memory 33 of the second embodiment and storage regions therefor are the same as those in the memory map described in the first embodiment with reference to FIG. 3.

An accelerator operation program of the second embodiment defines a traveling action of the car object in accordance with the degree of the accelerator's opening based on pressure applied by the player performing an operation of opening the accelerator (e.g., depressing the R button 66a). In the game program of the present invention, for example, the car object is programmed so as to reach maximum speed vₘₐₓ when the car object is at a speed of 0 and the R button 66a is kept operated with a 100% opening of the accelerator for a time period from time 0 to time t₁. Further, the car object is programmed so as to reach quasi-maximum speed v_{qmax} set for each degree of the accelerator's opening in accordance with the duration of time set for the degree of the accelerator's opening when the car object is at a speed of 0 and the R button 66a is kept operated with the degree of the accelerator's opening other than a 100% opening. Note that each of the maximum speed vₘₐₓ and the quasi-maximum speed v_{qmax} is a possible maximum speed at which the car object is able to travel in accordance with the degree of the accelerator's opening, and they are collectively referred to as a “maximum speed vₐₘₐₓ corresponding to the degree of the accelerator's opening”.

A braking operation program defines a traveling action of the car object in accordance with the intensity of braking power based on pressure applied by the player performing an operation of closing the accelerator (e.g., releasing the R button 66a) and an operation of applying braking (e.g., depressing the L button 66b). In the game program of the present invention, for example, the car object is programmed so as to decelerate to a speed of 0 when the car object is at the maximum speed vₘₐₓ and both the R button 66a and the L button 66b are left released (i.e., the car object is in a state where engine braking can be applied with a 0% opening of the accelerator and a 0% braking power) for a time period from time 0 to time t₁. It is also defined that if the player further performs a braking operation (e.g., depresses the L button 66b), the car object decelerates from the maximum speed vₘₐₓ to a speed of 0 in a deceleration time period shorter than the time period from time 0 to time t₁ having been set in accordance with the intensity of braking power. Note that when the braking operation is performed by, for example, depressing a B button 63, the player is able to designate either a 0% or 100% braking power, and therefore the braking operation program defines the deceleration time period in accordance with a 0% or 100% braking power.

Other programs and data stored in the main memory 33 are similar to those described in the first embodiment, and therefore detailed descriptions thereof are omitted. Also, acceleration sound data and deceleration sound data stored in the ARAM 35 are similar to those described in the first embodiment with reference to FIGS. 4A through 6. Accordingly, like data described in the first embodiment are denoted by the same reference numerals, and detailed descriptions thereof are omitted.

Next, an operation of the game apparatus 3 based on the game program according to the second embodiment is described by taking as an example a racing game in which the car object is controlled by the player's operation so as to travel on a course set in the game space. When the game apparatus 3 is turned on, the CPU 30 of the game apparatus 3 implements a startup program stored in a boot ROM (not shown) to initialize units in the game apparatus 3, e.g., the main memory 33. Then, a game program stored in the optical disc 4 is read onto the main memory 33 via the disc drive 40 and the disc I/F 41. Implementation of the game program is started and a game space is represented on the monitor 2 via the GPU 32, thereby starting the game. The acceleration sound data and the deceleration sound data stored in the optical disc 4 are stored into the ARAM 35 via the disc drive 40 and the disc I/F 4 in accordance with addresses as described above.

Initially, the player of the game apparatus 3 views a game image displayed on the monitor 2 to select a desired course of the racing game and a type of the car object to operate. The selection is made by the player operating input portions of the controller 6 in a manner as described above. Then, a game image corresponding to the course and car object selected by the player is displayed on the monitor 2.

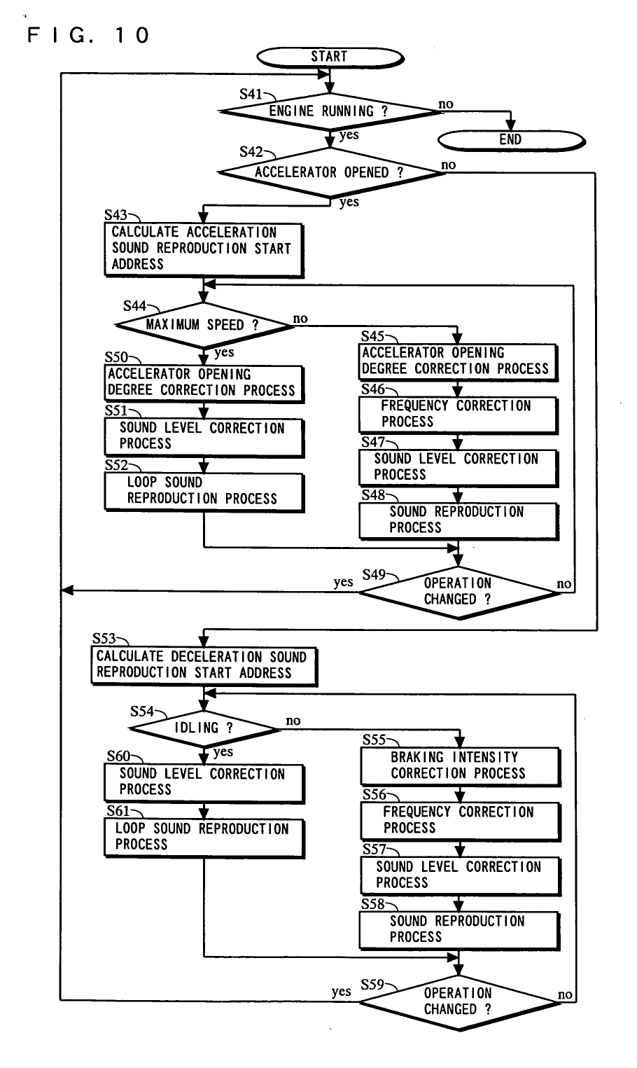

Referring to FIG. 10, described next is an engine sound reproduction process performed by the game apparatus 3 according to the second embodiment after the above process is performed. FIG. 10 is a flowchart illustrating the procedure of an engine sound reproduction process performed by the game apparatus 3.

In FIG. 10, the CPU 30 of the game apparatus 3 determines whether an engine of the car object in the game space is running (step S41), and also determines whether the accelerator is opened by the player operating the controller 6 (e.g., depressing the R button 66a) (step S42). Then, if the CPU 30 determines that the engine of the car object is running and the accelerator is opened, the procedure proceeds to the next step S43, and if the engine of the car object is running but the accelerator is closed, the procedure proceeds to the next step S53.

At step S43, in order to reproduce the sound of the engine of the car object which is accelerating, the CPU 30 calculates address Au of the acceleration sound data Du stored in the acceleration sound data storage region 351 of the ARAM 35, and the procedure proceeds to the next step. Specifically, in the calculation of step S43, the CPU 30 makes, based on the following expression (3), a calculation as to which one of m pieces of addresses Au0 through Au(m-1), at which the acceleration sound data Du corresponding to the acceleration range is stored, is the address from which the acceleration sound data Du is reproduced (an a'th address when counted from the address Au0).

a=mxvₓ/vₐₘₐₓ (3)

Here, vₓ is the current speed of the car object calculated based on numerical values stored in the accelerator and braking operation buffers of the data storage region 332. In this case, the numerical values are obtained based on a period of time for which the R button 66a is kept depressed, a period of time for which the R button 66a is left released, a period of time for which the L button 66b is kept depressed, and a period of time for which the L button 66b is left released, which are cumulatively calculated for each degree of pressure onto the button (i.e., for each degree of the accelerator's opening and each intensity of braking power) from a point in time at which the car object is at a speed of 0. As described above, vₐₘₐₓ is a maximum speed which corresponds to the degree of the accelerator's opening and is reached by the car object as a result of keeping the accelerator opened. The CPU 30 sets address Au(a-1), which is the a'th address when counted from address Au0 and is obtained based on the above expression (3), as an acceleration sound reproduction start address to be calculated at step S43.

Here, the CPU 30 calculates the acceleration sound reproduction start address by using the above expression (3) which multiplies the number of addresses m of the acceleration sound data Du corresponding to the acceleration range stored in the acceleration sound data storage region 351 by a ratio of the current speed vₓ of the car object to the maximum speed vₐₘₐₓ corresponding to the degree of the accelerator's opening. As described above, the acceleration sound data Du stored in the acceleration sound data storage region 351 is obtained based on recorded sound data of the real car accelerating from a speed of 0 to speed v at a constant acceleration speed. The speed v of the real car is replaced by the maximum speed vₐₘₐₓ corresponding to the degree of the accelerator's opening which is reached by the car object by keeping the accelerator opened in the game. Such replacement ensures that the CPU 30 accurately calculates the address Au(a-1) at which acceleration sound of the real car, which corresponds to a ratio of the current speed vₓ of the car object to the maximum speed vₐₘₐₓ corresponding to the degree of the accelerator's opening, is stored.

Next, the CPU 30 determines whether the speed of the car object in the game space has reached the maximum speed Vₐₘₐₓ corresponding to the degree of the accelerator's opening designated by the player's current operation (step S44). Specifically, if the degree of the accelerator's opening is 100%, the CPU 30 makes a determination based on the maximum speed vₘₐₓ, and if otherwise, the CPU 30 makes a determination based on a quasi-maximum speed V_{qmax} corresponding to the degree of the accelerator's opening. If the car object has not reached the maximum speed Vₐₘₐₓ corresponding to the degree of the accelerator's opening, the CPU 30 determines that the car object is accelerating, and the procedure proceeds to the next step S45. On the other hand, if the car object has reached the maximum speed vₐₘₐₓ corresponding to the degree of the accelerator's opening, the CPU 30 determines that the car object is traveling at the maximum speed vₐₘₐₓ in a high and constant speed state, and the procedure proceeds to the next step S50.

At step S45, the CPU 30 calculates an accelerator opening degree correction coefficient ak used for reproducing acceleration sound data Du stored at and after the acceleration sound reproduction start address Au(a-1) calculated at the above step S43, and the procedure proceeds to the next step. As described above, a maximum possible speed which can be reached by the car object and the number of revolutions of the engine at the maximum possible speed may differ depending on the degree of the accelerator's opening, and a required time period may also differ depending on the maximum possible speed to be reached. However, in the calculation using the above expression (3), the same acceleration sound reproduction start address is calculated for the same ratio of the current speed vₓ to the maximum speed vₐₘₐₓ corresponding to the degree of the accelerator's opening. As a result, the same acceleration sound data is reproduced for different speeds vₓ. Further, an engine sound reproduction time period required for reaching the maximum speed vₐₘₐₓ corresponding to the degree of the accelerator's opening is also invariable. At the above step S45, the accelerator opening degree correction coefficient ak is calculated as a frequency magnification by which the frequency of the engine sound to be reproduced is multiplied, in order to accurately reflect, on the engine sound to be reproduced, differences between speeds of the car object, between the numbers of revolutions of the engine, and between time periods required for reaching the maximum speed, which are all caused by a difference between degrees of the accelerator's opening. The CPU 30 calculates the accelerator opening degree correction coefficient using the following expression (4),

ak=aoₚx(ao₁₀₀−a₀₀)/100+ao₀ (4),

where aoₚ is the current degree of the accelerator's opening (0%-100%), ao₁₀₀ is a constant indicating a frequency magnification at a 100% opening of the accelerator, and ao₀ is a constant indicating a frequency magnification at a 0% opening of the accelerator. For example, in an initial setting, constant ao₁₀₀=1.0, and constant ao₀=0.3.

Next, the CPU 30 calculates a frequency correction coefficient used for reproducing acceleration sound data Du stored at and after the acceleration sound reproduction start address Au(a-1) calculated at the above step S43 (step S46), and the CPU 30 also calculates a sound level correction coefficient used for correcting a sound level at which the engine sound is reproduced (step S47). Processes performed at these steps S46 and S47 are respectively similar to those performed at steps S15 and S16 described in the first embodiment, and therefore detailed descriptions thereof are omitted. The procedure further proceeds to the next step.

Next, the CPU 30 performs a process for reproducing acceleration sound data Du stored at and after the acceleration sound reproduction start address Au(a-1) calculated at the above step S43 (step S48), and repeats processing of steps S45-S48 until the player changes the accelerator operation (i.e., the accelerator is closed) (step S49) or until the car object reaches the maximum speed vₐₘₐₓ corresponding to the degree of the accelerator's opening (step S44). If the CPU 30 determines that the player has closed the accelerator, the procedure returns to the above step S41 to continue the procedure. At the above step S48, the CPU 30 provides the DSP 34 with an instruction to sequentially read, as sound data, the acceleration sound data Du stored at and after the address Au(a-1) in the ARAM 35. Then, the DSP 34 multiplies the frequency of the sound data by the accelerator opening degree correction coefficient ak calculated at the above step S45 and the frequency correction coefficient calculated at the above step S46, adjusts a reproduction sound level using the sound level correction coefficient obtained at the above step S47, and outputs the engine sound from the loudspeakers 2a provided in the monitor 2 via the memory controller 31 and the audio I/F 39. In this sound reproduction process, unless the player's accelerator operation is changed (i.e., the accelerator is closed) or the car object reaches the maximum speed vₐₘₐₓ corresponding to the degree of the accelerator's opening, previously recorded acceleration sound data is continuously reproduced using, as a reproduction start point, the acceleration sound reproduction start address calculated at the above step S43. Since the frequency of the acceleration sound data stored in the ARAM 35 is multiplied by the accelerator opening degree correction coefficient ak, in the case where the degree of the accelerator's opening is not 100%, a reproduction frequency of the acceleration sound to be reproduced becomes relatively low in accordance with the degree of the accelerator's opening, and a time period required for reaching the maximum speed vₐₘₐₓ becomes relatively long in accordance with the degree of the accelerator's opening. Accordingly, it is possible to accurately reflect, on the engine sound to be reproduced, differences between speeds of the car object, between the numbers of revolutions of the engine, and between time periods required for reaching the maximum speed, which are all caused by a difference between degrees of the accelerator's opening.

On the other hand, at the above step S44, if the car object has reached the maximum speed vₐₘₐₓ corresponding to the degree of the accelerator's opening, the CPU 30 determines that the car object is running at the maximum speed vₐₘₐₓ in a high and constant speed state, and the procedure proceeds to step S50. At step S50, the CPU 30 calculates an accelerator opening degree correction coefficient ak used for reproducing acceleration sound data Du(m) through Du(n-1) stored at addresses Au(m) through Au (n-1) corresponding to the high and constant speed range, and the procedure proceeds to the next step. The process at step S50 is similar to that at the above step S45, and therefore detailed descriptions thereof are omitted.

Next, the CPU 30 calculates a sound level correction coefficient for correcting a sound level at which the engine sound is reproduced (step S51), and the procedure proceeds to the next step. The process at step S51 is similar to that at the above step S16 described in the first embodiment, and therefore detailed descriptions thereof are omitted.

Next, the CPU 30 performs a process for loop-reproducing acceleration sound data Du(m) through Du(n-1) stored at addresses Au(m) through Au(n-1) corresponding to the high and constant speed range (step S52). The procedure returns to the above step S50 to repeat this loop reproduction process so long as the accelerator is kept opened by the player (step S49). The CPU 30 provides the DSP 34 with an instruction to repeatedly read, as sound data, the acceleration sound data Du (m) through Du(n-1) corresponding to the high and constant speed range stored at addresses Au(m) through Au(n-1) in the ARAM 35. The DSP 34 multiplies the frequency of the sound data by the accelerator opening degree correction coefficient ak calculated at the above step S50, adjusts a reproduction sound level using the sound level correction coefficient obtained at the above step S51, and outputs the engine sound from the loudspeakers 2a provided in the monitor 2 via the memory controller 31 and the audio I/F 39. If the CPU 30 determines that the player has changed the accelerator operation (i.e., the accelerator has been closed) (step S49), the procedure returns to the above step S41 to continue the procedure.

On the other hand, at the above step S42, if the engine of the car object is running but the accelerator is closed, the procedure proceeds to step S53. At step S53, in order to reproduce the engine sound of the car object which is decelerating, the CPU 30 calculates address Ad of the deceleration sound data Dd stored in the deceleration sound data storage region 352 of the ARAM 35 in the same manner as in the above step S21 in the first embodiment, and the procedure proceeds to the next step. Specifically, in the calculation of step S53, the CPU 30 makes, based on the expression (2) used at the above step S21 which is reproduced below for ease of reference, a calculation as to which one of m pieces of addresses Ad0 through Ad(m-1), at which the deceleration sound data Dd corresponding to the deceleration range is stored, is the address from which the deceleration sound data Dd is reproduced (a b'th address when counted from the address Ad0).

b=m−(mxvₓ/vₘₐₓ) (2)

Here, vₓ is the current speed of the car object which is similar to the numerical value used at the above step S43, and vₘₐₓ is a maximum speed. The CPU 30 sets address Ad(b-1) calculated based on the above expression (2), which is a b'th address when counted from address Ad0, as a deceleration sound reproduction start address from which the engine sound is reproduced.

Next, the CPU 30 determines whether the car object in the game space is in an idling state at a speed of 0 (step S54). If the car object is not in an idling state at a speed of 0, the CPU 30 determines that the car object is decelerating, and the procedure proceeds to the next step S55. On the other hand, if the CPU 30 determines that the car object is in an idling state at a speed of 0, the procedure proceeds to the next step S60.

At step S55, the CPU 30 calculates a braking intensity correction coefficient bk used for reproducing deceleration sound data Dd stored at and after the deceleration sound reproduction start address Ad(b-1) calculated at the above step S53, and the procedure proceeds to the next step. As described above, if the player further performs a braking operation (e.g., depresses the L button 66b), the car object decelerates from the maximum speed vₘₐₓ to a speed of 0 in a time period shorter than a time period from time 0 to time t₁ set in accordance with a designated intensity of braking power. Specifically, if the player performs a braking operation with an arbitrary intensity of braking power, the car object decelerates at a deceleration rate which is relatively higher than a deceleration rate of deceleration by means of engine braking (i.e., a 0% braking power). However, in the calculation using the above expression (2), the same deceleration sound reproduction start address is calculated for the same ratio of the current speed vₓ to the maximum speed vₘₐₓ. As a result, the same deceleration sound data is reproduced for speeds with different deceleration time periods. At the above step S55, the braking intensity correction coefficient bk is calculated as a frequency magnification by which the frequency of the engine sound to be reproduced is multiplied, in order to accurately reflect, on the engine sound to be reproduced, differences between speeds of the car object and between the numbers of revolutions of the engine, which are all caused by a difference between intensities of braking power. The CPU 30 calculates the braking intensity correction coefficient bk using the following expression (5),

bk=(100−boₚ)×(boo−bo₁₀₀)/100+bo₁₀₀.

where boₚ is the current braking power (0%-100%), bo₀ is a constant indicating a frequency magnification at a 0% braking power, and bo₁₀₀ is a constant indicating a frequency magnification at a 100% braking power. For example, in an initial setting, constant bo₀=1.0, and constant bo₁₀₀=0.3.

Next, the CPU 30 calculates a frequency correction coefficient used for reproducing deceleration sound data Dd stored at and after the deceleration sound reproduction start address Ad(b-1) calculated at the above step S53 (step S56), and also calculates a sound level correction coefficient for correcting a sound level at which the engine sound is reproduced (step S57). Processes performed at steps S56 and S57 are respectively similar to those performed at the above steps S15 and S16, and therefore detailed descriptions thereof are omitted. The procedure further proceeds to the next step.

Next, the CPU 30 performs a process for reproducing the deceleration sound data Dd stored at and after the deceleration sound reproduction start address Ad(b-1) calculated at the above step S53 (step S58), and repeats processing of steps S55-S58 after the player stops a braking operation until the accelerator is opened (step S59) or until the car object arrives in an idling state at a speed of 0 (step S54). If the CPU 30 determines that the player has changed the accelerator operation (i.e., the braking operation is stopped and the accelerator is opened), the procedure returns to the above step S41 to continue the procedure. At the above step S58, the CPU 30 provides the DSP 34 with an instruction to sequentially read, as sound data, the deceleration sound data Dd stored at and after the address Ad(b-1) in the ARAM 35. Then, the DSP 34 multiplies the frequency of the sound data by the braking intensity correction coefficient bk calculated at the above step S55 and the frequency correction coefficient obtained at the above step S56, adjusts a reproduction sound level using the sound level correction coefficient obtained at the step S57, and outputs the engine sound from the loudspeakers 2a provided in the monitor 2 via the memory controller 31 and the audio I/F 39. In this sound reproduction process, unless the player's accelerator operation is changed (i.e., the braking operation is stopped and the accelerator is opened) or the car object arrives in an idling state at a speed of 0, previously recorded deceleration sound data is continuously reproduced using, as a reproduction start point, the deceleration sound reproduction start address calculated at the above step S53. Since the frequency of the deceleration sound data stored in the ARAM 35 is multiplied by the braking intensity correction coefficient bk, in the case where the intensity of braking power is not 0% (only engine braking is applied), the deceleration sound is reproduced at a relatively low reproduction frequency corresponding to the intensity of braking power. Accordingly, it is possible to accurately reflect, on reproduced engine sound, differences between speeds of the car object and between the numbers of revolutions of the engine, which are all caused by a difference between intensities of braking power.

On the other hand, at the above step S54, if the CPU 30 determines that the car object is in an idling state at a speed of 0, the procedure proceeds to step S60. At step S60, the CPU 30 calculates a sound level correction coefficient for correcting a sound level at which the engine sound is reproduced, and the procedure proceeds to the next step. Processing at step S60 is similar to that at the above step S16, and therefore detailed descriptions thereof are omitted.

Next, the CPU 30 performs a process for loop-reproducing deceleration sound data Dd(m) through Dd(n-1) stored at addresses Ad(m) through Ad(n-1) corresponding to the idling range (step S61). The procedure returns to the above step S60 to repeatedly perform this loop reproduction process so long as the player keeps at least the accelerator closed (step S59) and the car object maintains the idling state at a speed of 0 (step S54). The CPU 30 provides the DSP 34 with an instruction to repeatedly read, as sound data, the deceleration sound data Dd (m) through Dd(n-1) corresponding to the idling range stored at addresses Ad(m) through Ad(n-1) in the ARAM 35. The DSP 34 adjusts the reproduction sound level using the sound level correction coefficient obtained at the above step S60, and outputs the engine sound from the loudspeakers 2a provided in the monitor 2 via the memory controller 31 and the audio I/F 39. If the CPU 30 determines that the player has changed the accelerator operation (i.e., at least the accelerator has been opened), the procedure returns to the above step S41 to continue the procedure.

If the CPU 30 determines at the above step S41 that the engine is not running, the engine sound reproduction process according to the flowchart of FIG. 10 is terminated.

Note that in the second embodiment, as in the first embodiment, although the ARAM 35 has stored therein the acceleration sound data Du and the deceleration sound data Dd, each equally divided into n pieces of data, and each of a portion of the acceleration sound data Du corresponding to the acceleration range and a portion of the deceleration data Dd corresponding to the deceleration range is equally divided into m pieces of data, the number of pieces of data to be divided into may not be equally n or m. By performing the above-described processing based on the flowchart of FIG. 10 and making an address calculation using the above expressions (2) and (3), similar processing can be realized even if the number of pieces of data to be divided into is not equal between the acceleration sound data Du and the deceleration sound data Dd.

As described above, in the game system 1 according to the second embodiment of the present invention, sounds of the engine corresponding to traveling actions, such as acceleration, deceleration, idling, and maximum and constant speed states, of the car object in the game space are reproduced using previously recorded sound data obtained by running a real car, even if in a game which enables the player to arbitrarily control the degree of the accelerator's opening and the intensity of braking power. Therefore, it is possible to reproduce the sound of the engine close to the sound of the real car's engine. Also, by correcting the frequency of acceleration or deceleration sound in accordance with the degree of the accelerator's opening or the intensity of braking power, it is made possible to reproduce a natural sound of acceleration or deceleration.

Note that although the first and second embodiments have been described by taking as an example a racing game in which the car object is controlled by the player's operation so as to travel on a course set in the game space, the present invention is applicable to other types of games. For example, the present invention is applicable in sound reproduction of a game in which an object, such as a train or an airplane, moves at defined rates of acceleration and deceleration.

For reproduction of the engine sound, it is conceivable that either one of engine sounds of acceleration and deceleration is recorded to the ARAM 35, and said one engine sound is reproduced in reverse when the other engine sound is required to be reproduced during the game. However, each of the engine sounds of acceleration and deceleration contains, for example, resonant sounds characteristic thereto, sounds of intake and exhaust, mechanical sounds which are variable depending on the condition of load on the engine, and so on, and it is not possible to reproduce such characteristic sounds by reverse reproduction. Therefore, in order to reproduce a natural sound of acceleration or deceleration using the present invention, it is preferred to use two types of continuous sound data for acceleration and deceleration to reproduce the engine sound in the game.

Further, although the above embodiments have been described with respect to a case where the optical disc 4 is used as a data storage medium for a game program, etc., a storage medium for recording a game program of the present invention may be provided in other forms. For example, in the case where the game program of the present invention is processed by a portable game apparatus, the game program recorded in a game cartridge or the like may be read to perform processing as described above. The game program may also be supplied through other types of media or communication lines.

While the invention has been described in detail, the foregoing description is in all aspects illustrative and not restrictive. It is understood that numerous other modifications and variations can be devised without departing from the scope of the invention.

What is claimed is:

1. A game apparatus which represents a game by a game image in which game an object moves in accordance with a player's operation, comprising:
an operating section for inputting, in accordance with the player's operation, at least acceleration operation input data for accelerating a movement of the object and deceleration operation input data for decelerating a movement of the object;
an acceleration sound storage section in which a series of acceleration sound data of the object are stored in accordance with action parameters of the object;
a deceleration sound storage section in which a series of deceleration sound data of the object are stored in accordance with the action parameters of the object;
a read position calculating section for selecting, based on operation input data inputted via the operating section, either one of the acceleration sound data and the deceleration sound data which are stored in the acceleration sound storage section and the deceleration sound storage section, respectively, and for calculating a read start position of selected sound data corresponding to a current action parameter of the object;
a sound data reading section for sequentially reading, from the read start position, the sound data selected by the read position calculating section; and
a sound output control section for emitting, as a sound, the sound data read by the sound data reading section.

2. The game apparatus according to claim 1, wherein for each change from one to the other between the acceleration operation input data and the deceleration operation input data which are inputted via the operating section, the read position calculating section changes a calculation target at the read start position from one to the other between the acceleration sound data and the deceleration sound data, while the sound data read section sequentially reads, in response to a change of the calculation target of the read position calculating section, sound data newly targeted for calculation from the read start position, thereby continuously reading different types of sound data before and after the change of the calculation target.

3. The game apparatus according to claim 1, wherein when the sound data reading section is sequentially reading the acceleration sound data in response to the acceleration operation input data from the operating section, if there is an input of the deceleration operation input data from the operating section, the read position calculating section calculates the read start position of the deceleration sound data based on an action parameter corresponding to a read position of the acceleration sound data being read by the sound data reading section.

4. The game apparatus according to claim 1, wherein when the sound data reading section is sequentially reading the deceleration sound data in response to the deceleration operation input data from the operating section, if there is an input of the acceleration operation input data from the operating section, the read position calculating section calculates the read start position of the acceleration sound data based on an action parameter corresponding to a read position of the deceleration sound data being read by the sound data reading section.

5. The game apparatus according to claim 1, wherein:
the acceleration sound data stored in the acceleration sound storage section contains at least sound data corresponding to an acceleration range where the object accelerates from a minimum speed to a maximum speed at a constant acceleration rate; and
the deceleration sound data stored in the deceleration sound storage section contains at least sound data corresponding to a deceleration range where the object decelerates from the maximum speed to the minimum speed at a constant deceleration rate.

6. The game apparatus according to claim 5, wherein
the acceleration sound data stored in the acceleration sound storage section further contains sound data corresponding to a maximum and constant speed range, where the object moves at the maximum and constant speed, and the sound data corresponding to a maximum and constant speed range is sequential in address to the sound data corresponding to the acceleration range; and
if the acceleration operation input data is continuously inputted from the operating section for a period of a prescribed time or more, the sound data reading section repeatedly reads the acceleration sound data corresponding to the maximum and constant speed range.

7. The game apparatus according to claim 5, wherein
the deceleration sound data stored in the deceleration sound storage section further contains sound data corresponding to a minimum and constant speed range, where the object moves at the minimum and constant speed, and the sound data corresponding to a minimum and constant speed range is sequential in address to the sound data corresponding to the deceleration range; and
if the deceleration operation input data is continuously inputted from the operating section for a period of a prescribed time or more, the sound data reading section repeatedly reads the deceleration sound data corresponding to the minimum and constant speed range.

8. The game apparatus according to claim 1, wherein:
the operating section is able to input acceleration operation input data for accelerating the movement of the object at an arbitrary rate of speed in accordance with a degree of operation designated by the player; and
the sound output control section includes an acceleration sound frequency correcting section for correcting a frequency of the acceleration sound data read by the sound data reading section in accordance with a rate of acceleration movement indicated by the acceleration operation input data.

9. The game apparatus according to claim 1, wherein:
the operating section is able to input deceleration operation input data for decelerating the movement of the object at an arbitrary rate of speed in accordance with a degree of operation designated by the player; and
the sound output control section includes a deceleration sound frequency correcting section for correcting a frequency of the deceleration sound data read by the sound data reading section in accordance with a rate of deceleration movement indicated by the deceleration operation input data.

10. The game apparatus according to claim 1, wherein:
the object is a vehicle; and
the action parameter corresponds to a speed of the vehicle.

11. A storage medium having recorded therein a game program causing a computer, which includes an operating section operated by a player, to implement a process for representing a game by a game image in which game an object moves in accordance with the player's operation, the game program causing the computer to implement:
an input step for inputting, in accordance with an operation of the operating section, at least acceleration operation input data for accelerating a movement of the object and deceleration operation input data for decelerating a movement of the object;
a read position calculating step for selecting, based on operation input data inputted at the input step, either one of the object's acceleration sound data and deceleration sound data, which are sequential to each other and previously stored in accordance with action parameters of the object, and for calculating a read start position of selected sound data corresponding to a current action parameter of the object;
a sound data reading step for sequentially reading, from the read start position, the sound data selected at the read position calculating step; and
a sound output control step for emitting, as a sound, the sound data read at the sound data reading step.

12. The storage medium having stored therein a game program according to claim 11, wherein for each change from one to the other between the acceleration operation input data and the deceleration operation input data which are inputted via the operating section at the input step, the read position calculating step changes a calculation target at the read start position from one to the other between the acceleration sound data and the deceleration sound data, while the sound data read step sequentially reads, in response to a change of the calculation target at the read position calculating step, sound data newly targeted for calculation from the read start position, thereby continuously reading different types of sound data before and after the change of the calculation target.

13. The storage medium having recorded therein a game program according to claim 11, wherein when the sound data reading step is sequentially reading the acceleration sound data in response to the acceleration operation input data inputted at the input step, if the input step inputs the deceleration operation input data, the read position calculating step calculates the read start position of the deceleration sound data based on an action parameter corresponding to a read position of the acceleration sound data being read at the sound data reading step.

14. The storage medium having recorded therein a game program according to claim 11, wherein when the sound data reading step is sequentially reading the deceleration sound data in response to the deceleration operation input data inputted at the input step, if the input step inputs the acceleration operation input data, the read position calculating step calculates the read start position of the acceleration sound data based on an action parameter corresponding to a read position of the deceleration sound data being read at the sound data reading step.

15. The storage medium having recorded therein a game program according to claim 11, wherein:
the previously stored acceleration sound data contains at least sound data corresponding to an acceleration range where the object accelerates from a minimum speed to a maximum speed at a constant acceleration rate; and
the previously stored deceleration sound data contains at least sound data corresponding to a deceleration range where the object decelerates from the maximum speed to the minimum speed at a constant deceleration rate.

16. The storage medium having recorded therein a game program according to claim 15, wherein the previously stored acceleration sound data further contains sound data corresponding to a maximum and constant speed range, where the object moves at the maximum and constant speed, and the sound data corresponding to a maximum and constant speed range is sequential in address to the sound data corresponding to the acceleration range; and
if the acceleration operation input data is continuously inputted at the input step for a period of a prescribed time or more, the sound data reading step repeatedly reads the acceleration sound data corresponding to the maximum and constant speed range.

17. The storage medium having recorded therein a game program according to claim 15, wherein the previously stored deceleration sound data further contains sound data corresponding to a minimum and constant speed range, where the object moves at the minimum and constant speed, and the sound data corresponding to a minimum and constant speed range is sequential in address to the sound data corresponding to the deceleration range; and
if the deceleration operation input data is continuously inputted at the input step for a period of a prescribed time or more, the sound data reading step repeatedly reads the deceleration sound data corresponding to the minimum and constant speed range.

18. The storage medium having recorded therein a game program according to claim 11, wherein:
the input step inputs acceleration operation input data for accelerating the movement of the object at an arbitrary rate of speed in accordance with a degree of operation designated by the player via the operating section; and
the sound output control step includes an acceleration sound frequency correcting step for correcting a frequency of the acceleration sound data read at the sound data reading step in accordance with a rate of acceleration movement indicated by the acceleration operation input data.

19. The storage medium having recorded therein a game program according to claim 11, wherein:
the input step inputs deceleration operation input data for decelerating the movement of the object at an arbitrary rate of speed in accordance with a degree of operation designated by the player via the operating section; and
the sound output control step includes a deceleration sound frequency correcting step for correcting a frequency of the deceleration sound data read at the sound data reading step in accordance with a rate of deceleration movement indicated by the deceleration operation input data.

20. The storage medium having recorded therein a game program according to claim 11, wherein:
the object is a vehicle; and
the action parameter corresponds to a speed of the vehicle.
